(19) United States
(12) Patent Application Publication
(10) Pub. No.: US 2026/0370079 A1
(43) Pub. Date: Nov. 19, 2026

(54) ELECTRIC MOTOR

(71) Applicant: CORNING INCORPORATED, CORNING, NY (US)

(72) Inventors: Joseph Leroy Morse, Little River, SC (US); David Jeshua Streit, Wallace, NC (US)

(21) Appl. No.: 19/674,671

(22) Filed: May 12, 2026

Related U.S. Application Data
(60) Provisional application No. 63/808,190, filed on May 19, 2025.

(51) Int. Cl. H02K 5/16; H02K 1/14; H02K 1/278; H02K 5/18; H02K 5/20

(52) U.S. Cl. CPC H02K 5/163; H02K 1/146; H02K 1/278; H02K 5/18; H02K 5/20; H02K 2213/03

(57) ABSTRACT

An electric motor may include: a rotor having a rotor rotational axis, a rotor shaft configured to rotate about the rotor rotational axis, and a magnetic core; a stator having a stator housing, and a stator winding received in the stator housing; and a bearing having a first bearing race and a second bearing race disposed radially outward from the first bearing race. The first bearing race may be coupled to the stator housing and may remain stationary relative to the stator housing during operation of the electric motor. The second bearing race may be coupled to the rotor shaft and may rotate with the rotor shaft during operation of the electric motor. The first bearing race and the second bearing race may cooperate to limit relative axial movement between the rotor and the stator while facilitating relative rotation between the rotor and the stator.

### CROSS-REFERENCE TO RELATED APPLICATIONS

This application claims the benefit of priority of U.S. Application Ser. No. 63/808,190 filed on May 19, 2025, the content of which is relied upon and incorporated herein by reference in its entirety.

### FIELD

The present disclosure generally relates to electric motors, including ultra-thin servo motors.

### BACKGROUND

Motors are frequently used as a driving mechanism. Conventional motor solutions tend to have a long axial dimension and/or size, which increases equipment envelopes and costs. Additionally, conventional motors typically cannot withstand challenging environmental conditions of heat and/or corrosive gas exposure. Thus, there is a need for improved motor designs.

### SUMMARY

In some embodiments, an electric motor may include a rotor, a stator, and a bearing. In some embodiments, the rotor may include a rotor rotational axis, a rotor shaft configured to rotate about the rotor rotational axis, and a magnetic core. In some embodiments, the stator may include a stator housing, and a stator winding received in the stator housing. In some embodiments, the bearing may include a first bearing race, a second bearing race, and rollers disposed between the first bearing race and the second bearing race. In some embodiments, the first bearing race may be coupled to the stator housing such that the first bearing race may remain stationary relative to the stator housing during operation of the electric motor. In some embodiments, the second bearing race may be disposed radially outward from the first bearing race and may be coupled to the rotor shaft such that the second bearing race may rotate with the rotor shaft during the operation of the electric motor. In some embodiments, the first bearing race and the second bearing race may be configured to cooperate to limit relative axial movement between the rotor and the stator during the operation of the electric motor.

In some embodiments, an electric motor may include a rotor configured to rotate about a rotor rotational axis, a stator, and a bearing. In some embodiments, the bearing may include a first bearing race coupled to the stator, a second bearing race coupled to the rotor disposed radially outward from the first bearing race, and rollers disposed between the first bearing race and the second bearing race. In some embodiments, the first bearing race, the second bearing race, and the rollers may be configured to cooperate to facilitate relative rotational movement between the rotor and stator. In some embodiments, the first bearing race and the second bearing race may be further configured such that relative axial movement between the rotor and the stator may be limited at least impart by the first bearing race and the second bearing race.

In some embodiments, an electric motor may include a rotor configured to rotate about a rotor rotational axis, a stator, and a bearing configured to facilitate relative rotational movement between the rotor and stator and configured to limit relative axial movement between the rotor and the stator. In some embodiments, the electric motor may further include an interior cooling channel configured for directing a cooling fluid to flow into the electric motor. In some embodiments, the electric motor may be configured to deliver the cooling fluid through a gap between the stator and the rotor. In some embodiments, the electric motor may be further configured to allow the cooling fluid to exit from the electric motor through a gap at a surface at an axial end of the electric motor.

Additional features and advantages are set forth in the Detailed Description that follows, and in part will be readily apparent to those skilled in the art from the description or recognized by practicing the embodiments as described in the written description and claims hereof, as well as the appended drawings. It is to be understood that both the foregoing general description and the following Detailed Description are merely exemplary, and are intended to provide an overview or framework to understand the nature and character of the claims.

### BRIEF DESCRIPTION OF THE DRAWINGS

The accompanying drawings are included to provide a further understanding, and are incorporated in and constitute a part of this specification. The drawings illustrate one or more embodiment(s), and together with the Detailed Description serve to explain principles and operation of the various embodiments. As such, the disclosure will become more fully understood from the following Detailed Description, taken in conjunction with the accompanying figures.

FIG. 1 shows a perspective view of an exemplary electric motor.

FIG. 2 shows another perspective view opposite the perspective view of the exemplary electric motor of FIG. 1.

FIG. 3 shows an exploded view of the electric motor of FIG. 1.

FIG. 4 shows a cross-sectional view of the exemplary electric motor taken along plane A-A of FIG. 1.

FIG. 5 shows a perspective view of a bearing race of a bearing of the electric motor of FIG. 1.

FIG. 6 shows a perspective view of a stator housing of a stator of the electric motor of FIG. 1.

FIG. 7 shows a portion of a stator winding of the stator of the electric motor of FIG. 1.

FIG. 8 shows an enlarged portion of the cross-sectional view of the electric motor of FIG. 4.

FIG. 9 shows simulation of the velocity magnitude (cm/s) of a cooling fluid through an inlet and an annular gap of the electric motor of FIG. 1.

FIG. 10 shows simulation of the velocity magnitude (cm/s) of the cooling fluid through the annular gap and exiting out at an annular slit of the electric motor 100.

FIG. 11 shows simulation of the temperature distribution within and around the electric motor of FIG. 1.

FIG. 12 shows simulation of the temperature distribution of a cross section of the electric motor taken along plane B-B of FIG. 11.

FIG. 13 schematically illustrates an exemplary system incorporating the electric motor of FIG. 1 for producing a soot preform.

FIG. 14 shows an interior side view of a portion of the system of FIG. 13 viewed in the direction C-C of FIG. 13.

FIG. 15 shows a cross-sectional view of the portion of the system of FIG. 14 taken along plane D-D of FIG. 14.

FIG. 16A shows a side view of the electric motor of FIG. 1 in the axial direction.

FIG. 16B shows a side view of the electric motor of FIG. 1 in the transverse direction.

FIG. 17A shows a perspective view of a conventional servo motor.

FIG. 17B shows a side view of the conventional servo motor of FIG. 17A in the axial direction.

FIG. 17C shows a side view of the conventional servo motor of FIG. 17A in the transverse direction.

FIG. 18 shows the simulation of the torque performance and winding losses of the electric motor of FIG. 1 based on direct quadrature model.

FIG. 19 shows the simulation of the efficiency curve for the electric motor of FIG. 1.

FIG. 20 shows flux density (T) finite element simulation for the electric motor of FIG. 1.

FIG. 21 shows magnetic vector potential (T*m) finite element simulation for the electric motor of FIG. 1.

FIG. 22 shows magnetic field intensity (A/m) finite element simulation for the electric motor of FIG. 1.

FIG. 23 shows relative magnetic permeability finite element simulation for the electric motor of FIG. 1.

FIG. 24 shows stator current density (A/m²) finite element simulation for the electric motor of FIG. 1.

FIG. 25 shows stator loss density (W/m³) finite element simulation for the electric motor of FIG. 1.

FIG. 26 shows back iron loss density (W/m³) finite element simulation for the electric motor of FIG. 1.

FIG. 27 shows magnet demagnetizing risk (A/m) finite element simulation for the electric motor of FIG. 1.

FIG. 28 shows measured torque performance of the electric motor of FIG. 1 as a function of current.

FIG. 29 shows an exemplary winding layout of the electric motor of FIG. 1.

FIG. 30 shows an exemplary stator slot and rotor layout of the electric motor of FIG. 1.

### DETAILED DESCRIPTION

The present disclosure is provided as an enabling teaching and can be understood more readily by reference to the following description, drawings, examples, and claims. To this end, those skilled in the relevant art will recognize and appreciate that many changes can be made to the various aspects of the embodiments described herein, while still obtaining the beneficial results. It will also be apparent that some of the desired benefits of the present embodiments can be obtained by selecting some of the features without utilizing other features. Accordingly, those who work in the art will recognize that many modifications and adaptations are possible and can even be desirable in certain circumstances and are a part of the present disclosure. Therefore, it is to be understood that this disclosure is not limited to the specific compositions, articles, devices, and methods disclosed unless otherwise specified. It is also to be understood that the terminology used herein is for the purposes of describing particular aspects only and is not intended to be limiting.

In this specification and in the claims which follow, “greater than or equal to” and “≥” are used interchangeably, “less than or equal to” and “_” are used interchangeably, “greater than” and “>” are used interchangeably, and “less than” and “<” are used interchangeably. When a parameter is described as greater than or equal to (or simply, ≥) a value, the parameter may be greater than (>) the referenced value or equal to (=) the referenced value. Similarly, when a parameter is described as less than or equal to (or simply, ≤) a value, the parameter may be less than (<) the referenced value or equal to (=) the referenced value.

When terms, such as “circular,” “square,” “linear,” “parallel,” “perpendicular,” “tangential,” “symmetrical,” “congruent,” “identical,” “coaxial,” “concentric,” “equiangular,” “equidistant,” etc., are used to describe geometrical properties, it is understood that actual geometrical properties may vary or deviate from these precise conditions due to factors including, but not limited to, manufacturing limitations or tolerances, material properties, environmental conditions, measurement inaccuracies, and so on. Thus, while the terms imply precise geometric properties, practical application acknowledges and permits minor discrepancies.

Directional terms as used herein—for example up, down, right, left, front, back, top, bottom—are made only with reference to the figures as drawn and are not intended to imply absolute orientation.

Various components described herein may be referred to as “directly connected” or “indirectly connected.” Components are directly connected when they are joined to one another with no intervening structure. Components may be joined by fusing, melting, welding, soldering, adhesives, or any other suitable attachment means. Components are “indirectly connected” when they are joined to one another with intervening structure. Examples of intervening structure include welding aids (e.g., frits, solders, fluxes), adhesives, and bonding materials. In some embodiments, components connected indirectly are connected only by a welding aid, adhesive, or bonding material. The term “connected” means “directly connected” or “indirectly connected.” Components “directly connected” to one another are said to be in direct contact with each other. Components “indirectly connected” to one another are said to be in indirect contact with each other. Components “connected” to one another are in direct or indirect contact with each other.

As used herein, the terms “upstream” and “downstream” refer to the relative positioning of unit operations with respect to the direction of flow of the process streams. A first unit operation of a system may be considered “upstream” of a second unit operation if process streams flowing through the system encounter the first unit operation before encountering the second unit operation. Likewise, a second unit operation may be considered “downstream” of the first unit operation if the process streams flowing through the system encounter the first unit operation before encountering the second unit operation.

As used herein, the term “linear” refers to relative distances/lengths between points. A “linear” distance/length may refer to a distance between two points along a straight line.

As used herein, the singular forms “a,” “an” and “the” include plural referents in addition to the single referent unless the context clearly dictates otherwise. Thus, for example, reference to “a” component includes aspects having one such component as well as two or more such components, unless the context clearly indicates otherwise.

Reference will now be made in detail to various embodiments. Whenever possible, the same reference numerals will be used throughout the drawings to refer to the same or like parts.

### Overview

The electric motors described herein has broad applications that uses brushless rotary servo motors, including applications within the optical fiber production equipment space. In the optical fiber production space, there is oftentimes a desire to manifold gas uniformly in various deposition steps, such as during preform blank production, as thermophoresis is one of the primary driving factors of deposition, and thus, even cooling of the preform via a gas supply is desired. Manifolding gas uniformly also helps to manage soot exhaust of the laydown process. The manifolding of gas can happen via stationary air manifolds, perforated moving bellows, moving sheets with manifolding features, etc. The moving solutions are sometimes utilized because deposition burners used in the laydown of preforms may move in relation to the preform blank, and/or airflow may be adjusted throughout the process to permit effective soot evacuation with varying process flows. Bellows may not be ideal as they can collapse and extend unevenly, affecting uniformity. Moving sheets can extend and retract more evenly and provide better uniformity but usually requires a driving system to move the sheets. If the sheet is rigid, linear actuators via screws, belts, linear motors, etc. can be used. However, the driving actuators for a rigid sheet can be more complex, and the rigid sheet may require a much larger footprint to fit the rigid sheet within the process enclosure, especially for large travel movements. If a sheet is sufficiently thin, it is possible to wrap the sheet on a drum and extend and retract the sheet from the drum to manifold the gas to save space.

Driving systems for such wrapped thin sheet may include belts and chains with a remotely mounted motors, conveyor motors inside of drums, or traditional servo motors mounted at the end of the drum. Belts and chains can be difficult to fit in the process envelope, may create wear particulate that may affect the purity needed in the process, and/or may have increased failure points. Conveyor motors may have a large gear reduction, which may increase the inertia seen when the sheet is actuated by an external device by the square, which can make the system inoperable due to the very large inertial force as the sheet switches direction and/or speed from retracting to extending. Traditional motors mounted at the end of the drum may not fit in the process area, thus requiring complex linkage methods, and gas tight dynamic seals to put the motor outside the process envelope which can create more cyclic failure points.

Described herein includes an electric motor which can be used for driving a moving sheet, more particularly, an ultra-thin electric motor for driving a thin sheet wrapped on a drum and for extending and retracting the thin sheet from and onto the drum to manifold gas. The ultra-thin electric motor described herein eliminates the cyclic failure modes while also eliminating the need for intermediate driving components or dynamic seals, minimizing complexity, and permitting fitment within the process envelope. The ultra-thin electric motors described herein also has greater applications in other equipment. For example, rotary positioning tables and actuators are used in many industries, such as semiconductor and pharmaceutical for various tasks including spin coating, encapsulation indexing, etc. These industries have similarly stringent requirements of purity, challenging environmental conditions, and/or the need to minimize the process envelope. The ultra-thin electric motor described herein can be incorporated into the equipment for processes employed by various industries to minimize equipment cost and space due to operating in clean rooms, vacuum chambers, etc., where small process envelope size increases can dramatically increase the cost of all the support equipment.

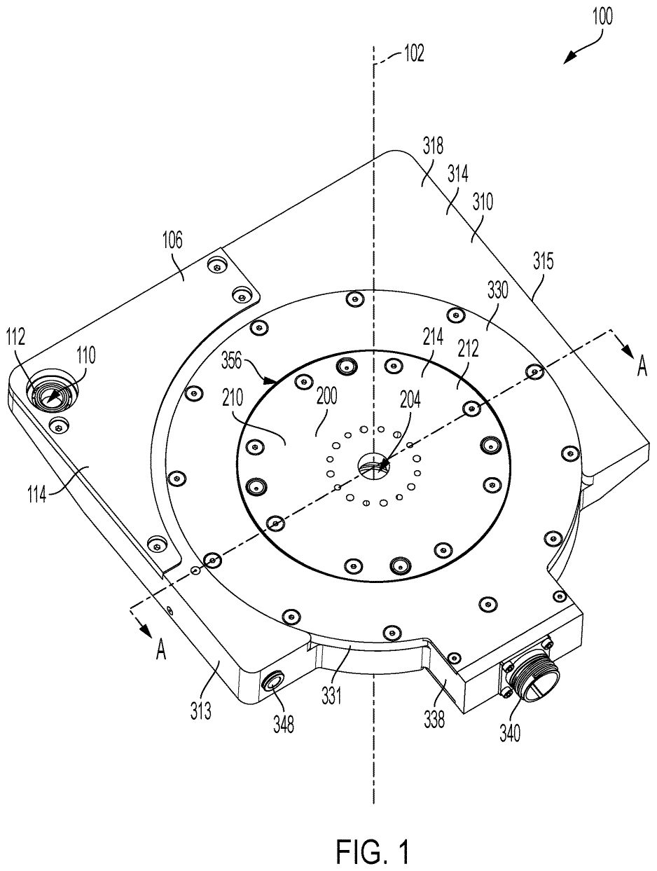

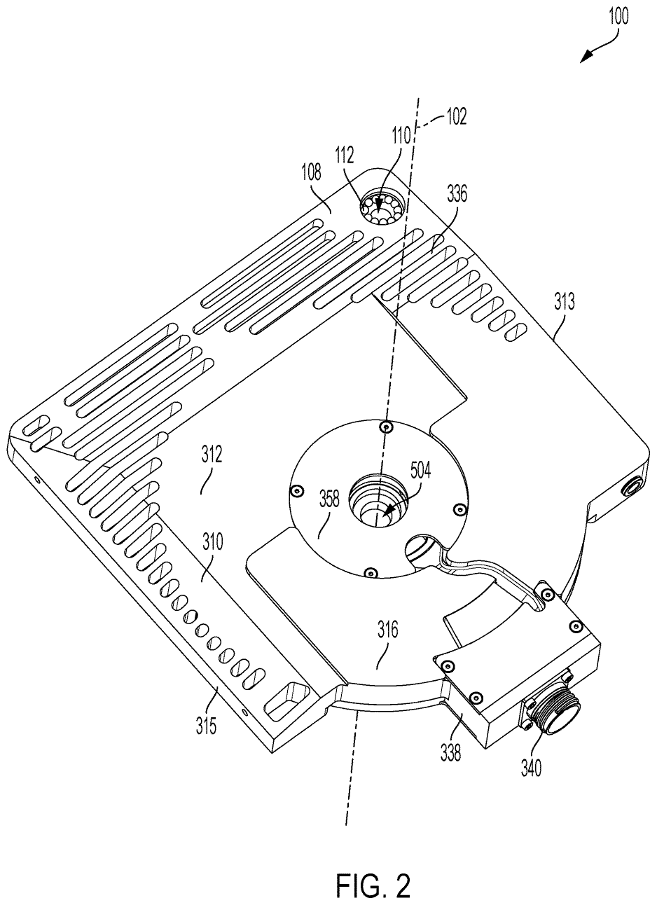

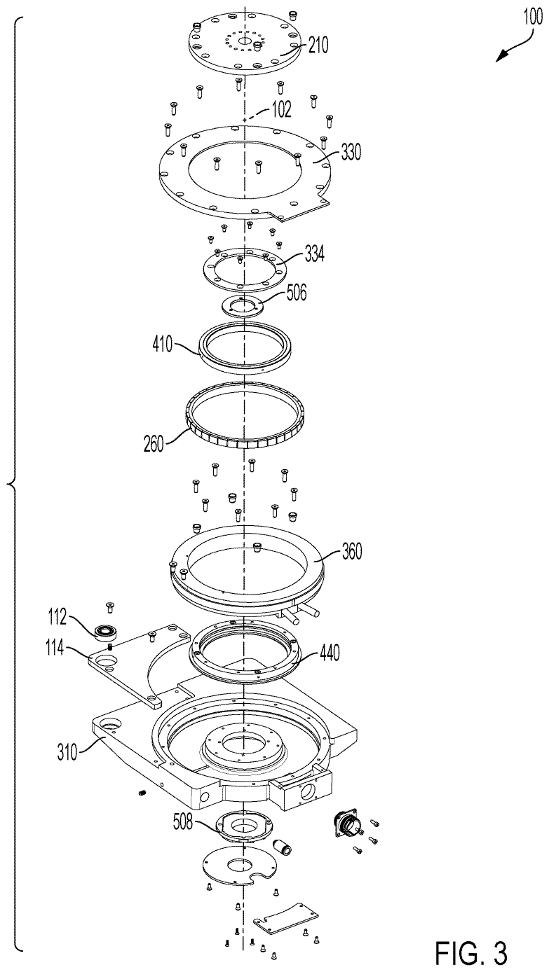

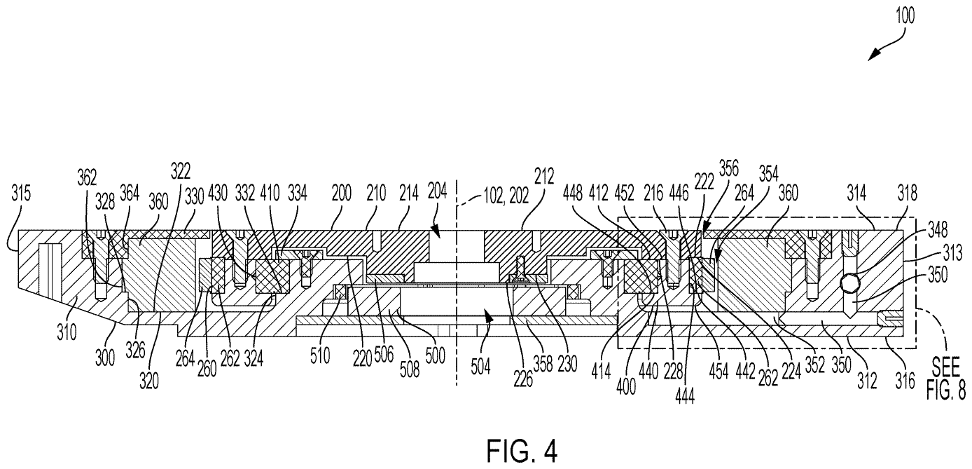

Referring to FIG. 1, a first perspective view of an exemplary electric motor 100 is shown. FIG. 2 shows a second perspective view of the exemplary electric motor 100 of FIG. 1. FIG. 3 shows an exploded view of the electric motor 100 of FIG. 1. FIG. 4 shows a cross-sectional view of the exemplary electric motor 100 taken along plane A-A of FIG. 1. The electric motor 100 may include a motor axis 102, a rotor 200, a stator 300, and a bearing 400 configured about the motor axis 102. In some embodiments, the bearing 400 may include a first bearing race 410 and a second bearing race 440, and rollers 430 disposed between the first bearing race 410 and the second bearing race 440. In some embodiments, the second bearing race 440 may be disposed radially outward from the first bearing race 410. Accordingly, the first bearing race 410 and the second bearing race 440 may also be referred to as the inner bearing race 410 and the outer bearing race 440, respectively. In some embodiments, the first bearing race 410 may be coupled to the stator 300, and the second bearing race 440 may be coupled to the rotor 200. As will be discussed in more detail below, the first bearing race 410 and the second bearing race 440 may be configured to facilitate relative rotational movement between the rotor 200 and the stator 300 and/or to limit relative axial movement between the rotor 200 and the stator 300.

### Rotor

### Rotor Shaft

The rotor 200 may include a rotor rotational axis 202 aligned with the motor axis 102, and a rotor shaft 210 configured to rotate about the rotor rotational axis 202. In some embodiments, the rotor shaft 210 may define a hollow bore 204 through which the rotor rotational axis 202 extends. In some embodiments, the hollow bore 204 of the rotor shaft 210 may be configured for mounting the electric motor 100 to, e.g., a drum for a thin sheet of an optical fiber preform manufacturing system, as will be discussed in more detail below.

In some embodiments, the rotor shaft 210 may include a first side 212 (or exterior side 212) and a second side 220 (or interior side 220) opposite the first side 212 in the axial direction. In some embodiments, the first side 212 may include a planar or substantially planar surface 214 that may define an axial end of the rotor shaft 210. In some embodiments, the second side 220 may include a contoured surface formed by steps, recesses, and/or protrusions on the second side 220 of the rotor shaft 210 as will be discussed in more detail below.

### Magnetic Core

The rotor 200 may further include a magnetic core 260. In some embodiments, the magnetic core 260 may include a back iron 262 and magnets 264 coupled to the back iron 262. In some embodiments, the magnets 264 may be bonded to the back iron 262 using an adhesive, such as thermoset epoxy. In some embodiments, the magnets 264 may be disposed radially outward from the back iron 262. In some embodiments, the back iron 262 may include a high magnetic permeability material, such as low-carbon silicon steel (e.g., M-19). In some embodiments, the magnets 264 may include magnetic materials (e.g., N42H-N48H magnets, preferably, N52H magnets) that produce high magnetic flux density for the rotor 200, which in turn allows the electric motor 100 described herein to produce a higher torque with a shorter rotor axial length, thereby reducing overall motor size in the axial direction.

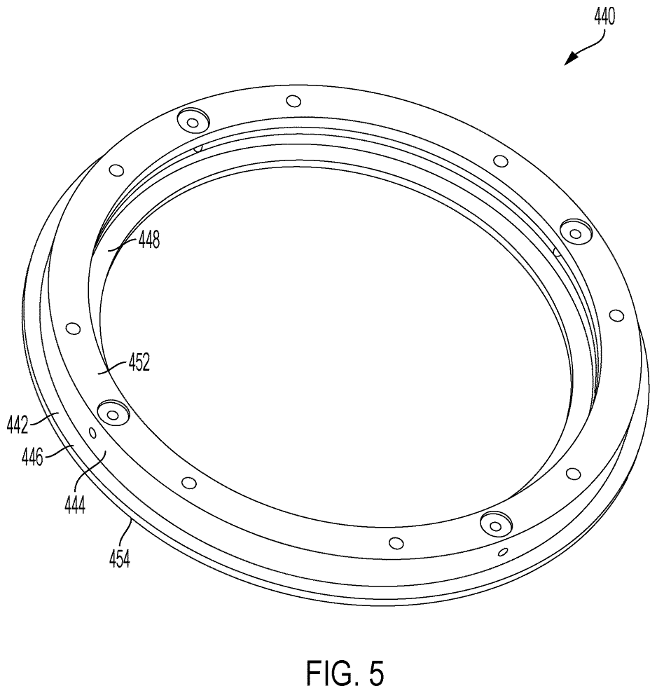

In some embodiments, the rotor 200 may be integrated with the bearing 400, or more specifically, the magnetic core 260 of the rotor 200 may be integrated with the second bearing race 440 of the bearing 400. Referring to FIG. 5, which shows the second bearing race 440 in a perspective view, in some embodiments, the second bearing race 440 may include an outer step 442, more specifically, a radially outward facing step 442, defined by a lateral surface 444 and a step surface 446 and configured to receive therein at least a portion of the magnetic core 260. In some embodiments, the second side 220 of the rotor shaft 210 may also include an outer step 222, more specifically radially outward facing step 222. The outer step 222 of the rotor shaft 210 and the outer step 442 of the second bearing race 440 may be aligned in the axial direction and collectively define an outer recess, more specifically, a radially outward facing recess, for receiving therein at least a portion of the magnetic core 260.

Specifically, in some embodiments, the back iron 262 of the magnetic core 260 may be coupled to the second bearing race 440 by fitting the back iron 262 into the outer step 442 of the second bearing race 440. For example, in some embodiments, the second bearing race 440 may be exposed to a low-temperature environment, e.g., liquid nitrogen, to cause the second bearing race 440 to shrink, and the back iron 262 may then be slid onto the thermally contracted second bearing race 440. Subsequent thermal expansion of the second bearing race 440 as the temperature increases creates a radially tight fit between the back iron 262 and the lateral surface 444 of the outer step 442, thereby forming a radially laminated rotor/bearing assembly. Such radially laminated rotor/bearing assembly may shorten the axial length of the electric motor 100 while maintaining load bearing capacity as the second bearing race 440, which is coupled to the magnetic core 260, the first bearing race 410, which is coupled to the stator housing 310 (described below in more detail), and the magnetic core 260 are in a radially arranged configuration, as opposed to an axially arranged configuration. The first bearing race 410 and the second bearing race 440 may be positioned radially inward from the magnetic core 260.

After the back iron 262 is fitted onto the second bearing race 440, the rotor shaft 210 may be coupled to the bearing 400, more specifically, to the second bearing race 440. In some embodiments, the rotor shaft 210 may include a surface portion 228 on the second side 220 extending radially inward from the lateral surface 444 of the outer step 442. In some embodiments, the second bearing race 440 may include a first surface 452 and a second surface 454 opposite the first surface 452 in the axial direction. In some embodiments, the first surface 452 and the second surface 454 may define two axial ends of the second bearing race 440, and thus, the distance between the first surface 452 and the second surface 454 may define the axial length of the second bearing race 440. Through-holes may be formed in the rotor shaft 210 extending from the first side 212 to the surface portion 228 of the second side 220, and cooperating recesses may be formed in the first surface 452 of the second bearing race 440 for receiving therein fasteners 216 for securing the second bearing race 440 to the second side 220 of the rotor shaft 210 in the axial direction.

When the bearing 400 is secured to the rotor shaft 210, the first surface 452 of the second bearing race 440 facing the surface portion 228 of the second side 220 of the rotor shaft 210 may or may not touch or be in direct contact with the surface portion 228 of the second side 220. In some embodiments, the outer step 222 and the surface portion 228 of the rotor shaft 210 may be configured such that when the rotor shaft 210 is secured to the bearing 400, the step surface 224 of the outer step 222 may be pressed against and in an abutting relationship with an axial end of the back iron 262. Thus, in some embodiments, the step surface 224 of the outer step 222 and the abutting axial end of the back iron 262 may exert axial load onto each other, while the surface portion 228 of the second side 220 of the rotor shaft 210 may be configured to not exert axial load directly on the first surface 452 of the second bearing race 440. In some embodiments, a clearance may be provided between the surface portion 228 of the second side 220 of the rotor shaft 210 and the first surface 452 of the second bearing race 440. A clearance may also exist between the surface portion 228 of the second side 220 of the rotor shaft 210 and a first surface 412 of the first bearing race 410 facing the rotor shaft 210 to facilitate the relative rotational movement between the rotor shaft 210 and the first bearing race 410. The clearances may be relatively small such that a greater thickness of the rotor shaft 210 may be maintained to provide structural support for the mounting fasteners 216, improve rotor stability, and/or limit rotor runout.

### Stator

In some embodiments, the stator 300 may include a stator housing 310 and a stator winding 360, such as a coated or encapsulated stator winding 360, received in the stator housing 310. It should be noted that in FIGS. 3 and 4, only the encapsulation of the stator winding 360 is shown, while the winding wires are omitted.

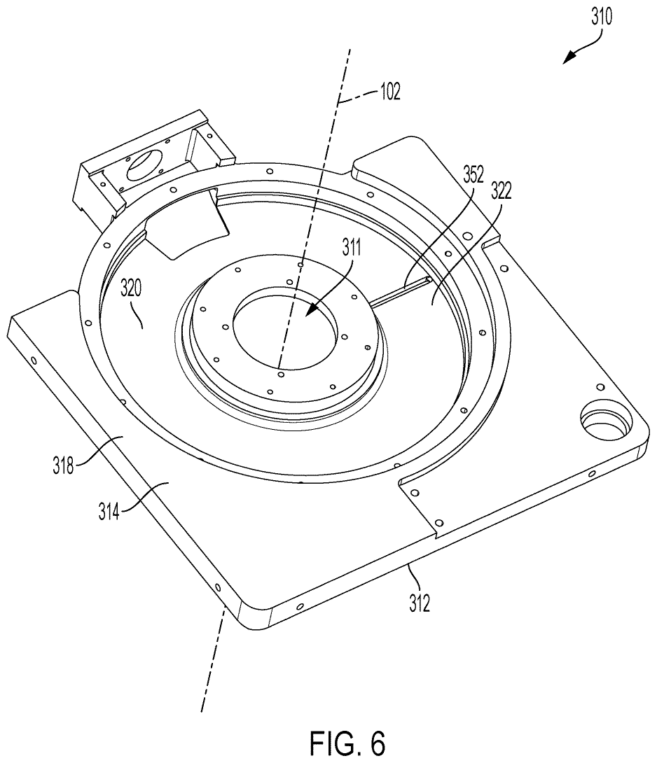

FIG. 6 shows a perspective view of the stator housing 310. Referring to FIGS. 4 and 6, in some embodiments, the stator housing 310 may include a hollow bore 311 centered around the motor axis 102. In some embodiments, the stator housing 310 may include a first side 312 and a second side 314 opposite the first side 312. In some embodiments, the first side 312 of the stator housing 310 may include a first surface 316 (see FIG. 2) that may be planar or substantially planar and that may define a first axial end of the stator housing 310. In some embodiments, the second side 314 of the stator housing 310 may include a second surface 318 that may be planar or substantially planar and that may define a second axial end of the stator housing 310 opposite of the first axial end. In some embodiments, the second surface 318 of the stator housing 310 may be aligned with the surface 214 of the first side 212 of the rotor shaft 210 in a direction transverse to the motor axis 102 (or simply, the transverse direction) (see FIG. 1). A distance between the first surface 316 and the second surface 318 of the stator housing 310 defines an axial length of the stator housing 310 which corresponds to the greatest separation between the first side 312 and the second side 314 of the stator housing 310 in the axial direction and which, in some embodiments, corresponds to an axial length of the electric motor 100.

Referring to FIG. 4, in some embodiments, the second side 314 of the stator housing 310 may further include a cavity 320 defined by an inner lateral wall 324, an outer lateral wall 326, and a base 322 extending between the inner lateral wall 324 and the outer lateral wall 326. The cavity 320 may be configured to receive therein at least a portion (or the entirety in some embodiments) of the stator winding 360, as well as at least a portion (or the entirety in some embodiments) of the bearing 400. In some embodiments, the stator winding 360 may be disposed radially outward from the bearing 400 and the magnetic core 260, and an annular gap 354 may exist between the magnetic core 260 and the stator winding 360.

In some embodiments, the stator winding 360, more specifically, the encapsulation of the stator winding 360, may be configured to include an annular protrusion 362 extending radially outward from an outer lateral surface 364 of the encapsulation of the stator winding 360. In some embodiments, a step 328 may be formed in the outer lateral wall 326. The step 328 and a retainer plate 330 may collectively define a recess for receiving therein the annular protrusion 362 of the stator winding 360 and cooperate to secure the stator winding 360 to the stator housing 310. As shown in the embodiment of FIG. 4, the stator winding 360 may be disposed radially outward from the bearing 400 and/or the rotor 200. Positioning the stator winding 360 further outward in the radial direction may achieve more effective heat dissipation from the stator winding 360, which may further facilitate operation of the electric motor 100 at stall for extended period of time (discussed in more detail below).

In some embodiments, a step 332 may be formed in the inner lateral wall 324 of the stator housing 310. The step 332 and a retainer plate 334 may collectively define a recess for receiving therein at least a portion of the first bearing race 410 and cooperate to secure the first bearing race 410 to the stator housing 310. The cavity 320 may be configured such that when the bearing 400 is received therein, gaps may be formed between the second bearing race 440 and the base 322 and the inner lateral wall 324 of the cavity 320 to facilitate rotation of the rotor shaft 210 relative to the stator housing 310.

Referring to FIGS. 1 and 2, in some embodiments, the electric motor 100 may include a connector 340 coupled to the stator housing 310. In some embodiments, the connector 340 may be coupled to a neck portion 338 of the stator housing 310. In some embodiments, power, feedback, and/or thermal signals may all be integrated to the connector 340 to further reduce space requirements for a compact design.

In some embodiments, the electric motor 100 may further include a through hole 110 extending from one side 106 to the opposite side 108 of the electric motor 100 in the axial direction and having a bearing 112 disposed therein for supporting a roller (discussed in more detail below). The bearing 112 may be retained by the stator housing 310 and a cover plate 114. The exterior surface of the cover plate 114, the second surface 318 of the stator housing 310, and the surface 214 of the first side 212 of the rotor shaft 210 may be coplanar or aligned in the transverse direction.

### Thermal Management

### Thermistor

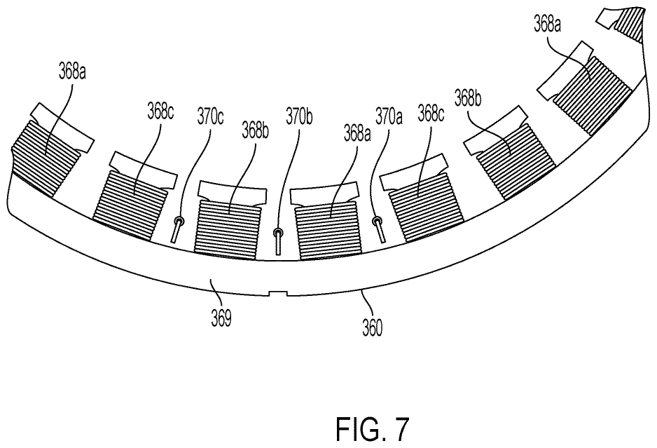

In some embodiments, the electric motor 100 described herein may include a multi-phase motor. In some embodiments, the electric motor 100 may be a three-phase motor. FIG. 7 shows a portion of the stator winding 360 with the encapsulation/coating removed. As shown, in some embodiments, the stator winding 360 may include winding units 368a, 368b, 368c configured as coil turns around spokes of a stator laminate back iron 369. The winding units 368a, 368b, 368c may be driven by three-phase DC current and configured for the electric motor 100 to operate as a three-phase motor. In some embodiments, the three-phase winding units 368a, 368b, 368c may be connected in a star configuration so as to provide better torque and efficiency performance at low speeds (e.g., near stall). However, in some embodiments, the three-phase winding units 368a, 368b, 368c may be connected in a Delta configuration for applications that may demand torque delivery at higher speeds.

In some embodiments, the stator winding 360 may further include temperature sensors 370 configured to measure the temperature of each winding phase separately, thereby allowing the electric motor 100 to operate at stall in different positions for extended period of time and the majority or most of the load is only on one or two of the phases while ensuring the phase(s) under the most load do not overheat, which can be particular beneficial for the electric motor 100 to operate as a constant force spring (discussed in more detail below). In some embodiments, each of the temperature sensors 370 may be disposed in a stator slot between adjacent winding units 368. In some embodiments, the temperature sensors 370 may include thermistors, such as thermistors configured for a linear temperature measurement curve in the operating range of the electric motor 100. The electric motor 100 may further include a feedback device (discussed in more detail below) configured to determine the phase at the highest temperature and transmit such information to the servo drive of the electric motor 100.

### Corrosion-Resistant Construction

In some embodiments, the stator housing 310, the rotor shaft 210, the retainer plate 330, and/or the cover plate 114 may be made of metal and/or alloy thereof. In some embodiments, the stator housing 310, the rotor shaft 210, the retainer plate 330, and/or the cover plate 114 may be made of aluminum and/or alloy thereof, providing superior heat dissipation and further extending the power/size ratio compared to a steel or stainless-steel construction. In some embodiments, the surfaces of the stator housing 310, the rotor shaft 210, the retainer plate 330, and/or the cover plate 114 may include anodized aluminum to resist corrosion, which may allow the electric motor 100 to operate in a corrosive environment, such as exposure to an acidic environment.

### Integrated Heat Sink

In some embodiments, the stator housing 310 may include heat sink fins 336 (see FIG. 2) disposed on the exterior of the stator housing 310. In some embodiments, the heat sink fins 336 may be configured to increase natural convective cooling to permit effective heat dissipation, allowing less thermal mass to be built in the electric motor 100 and further enabling a compact design.

### Active Cooling/Purge

In some embodiments, the stator housing 310 may be configured with conduits to allow a cooling fluid, such as compressed air, to flow through the stator housing 310 and the interior of the electric motor 100. For example, in some embodiments, the stator housing 310 may be configured to route the compressed air around the stator winding 360 to provide forced air cooling to the stator winding 360, which may further improve the high continuous and/or peak torque capability of the electric motor 100 for its compact design.

In some embodiments, the electric motor 100, more specifically, the stator housing 310, may include an inlet 348, e.g., an air inlet 348 (see also FIG. 1), for flowing into the interior of the electric motor 100 the cooling fluid. In some embodiments, the stator housing 310 may further include one or more fluid channels 350 (see FIG. 4) for flowing the cooling fluid through the electric motor 100. In some embodiments, the stator housing 310 may further include a groove 352 (see also FIG. 6) formed in the base 322 of the cavity 320 and in fluid communication with the fluid channels 350. When assembled, the stator winding 360, more specifically, the encapsulation thereof, may cover the groove 352, and the stator winding 360 and the stator housing 310 collectively define an extension of the fluid channels 350 to allow the cooling fluid to enter the space between the stator 300 and the rotor 200 to cool the stator winding 360.

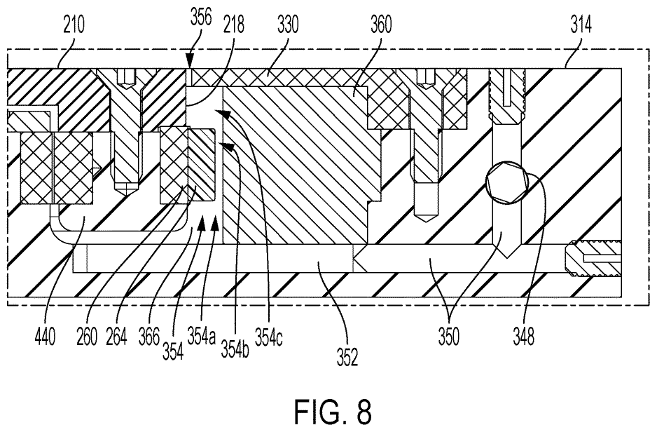

FIG. 8 shows an enlarged view of a portion of the cross-sectional view of the electric motor 100 of FIG. 4. As shown in FIG. 8, an annular gap 354 may be formed between the stator winding 360, in particular, the encapsulation of the stator winding 360, and the rotor 200. The encapsulation of the stator winding 360 may provide insulation, as well as serving as thermal mass for transferring heat from the encapsulated winding units 368 to the cooling fluid passing through the annular gap 354.

In some embodiments, the annular gap 354 may include a first annular gap portion 354a proximate to and in fluid communication with the groove 352, a second annular gap portion 354b extending from the first annular gap portion 354a, and a third annular gap portion 354c extending from the second annular gap portion 354b. In some embodiments, the first annular gap portion 354a may be defined by an inner lateral surface 366 of the encapsulation of the stator winding 360 and the second bearing race 440. In some embodiments, the second annular gap portion 354b may be defined by the inner lateral surface 366 of the encapsulation of the stator winding 360 and the magnetic core 260. In some embodiments, the third annular gap portion 354c may be defined by the inner lateral surface 366 of the encapsulation of the stator winding 360 and an outer lateral surface 218 of the rotor shaft 210. In some embodiments, the second annular gap portion 354b may include a reduced annular width than the first annular gap portion 354a and/or the third annular gap portion 354c due to the radially outward protruding configuration of the magnets 264 of the magnetic core 260 from the outer lateral surface 218 of the rotor shaft 210 and/or the second bearing race 440.

Without intending to be bound by theory, in some embodiments, the reduced annular width of the second annular gap portion 354b may create a pressure differential between the first annular gap portion 354a and the third annular gap portion 354c, with the pressure in the first annular gap portion 354a being greater than the third annular gap portion 354c. The higher pressure in the first annular gap portion 354a may facilitate the distribution of the cooling fluid around the entire first annular gap portion 354a, which may then travel through the entire second annular gap portion 354b and the entire third annular gap portion 354c. As the cooling fluid passes through the annular gap 354, the cooling fluid may absorb the heat from the stator winding 360, thereby achieving effective cooling of the stator winding 360.

After passing through the annular gap 354, the cooling fluid may exit the electric motor 100 through an annular slit 356 formed by the outer lateral surface 218 of the rotor shaft 210 and the retainer plate 330. In some embodiments, the annular slit 356 may include a reduced annular width as compared to the third annular gap portion 354c, which may create a pressure drop from the third annular gap portion 354c to the exterior adjacent the annular slit 356. Such pressure drop may further facilitate even distribution of the cooling fluid around the entire third annular gap portion 354c.

In addition to cooling the stator winding 360, the flow of the cooling fluid from the inlet 348, through the fluid channels 350, the groove 352, the annular gap 354, and the annular slit 356 to the exterior of the electric motor 100, may also serve as a seal to prevent any contaminants from entering into the interior of the electric motor 100. Moreover, the flow of the cooling fluid may further serve as an air purge such that the interior components of the electric motor 100 may be protected from the exterior environment which may be corrosive. As discussed above, the stator housing 310, the rotor shaft 210, and various other exterior components may be formed of a corrosion-resistant material, such as anodized aluminum, which, when combined with the air purge by the cooling fluid, may allow the electric motor 100 to withstand very corrosive applications.

In some embodiments, to provide effective cooling and/or heat dissipation for the electric motor 100, the flow rate of the cooling fluid at the inlet 348 may be greater than or equal to (i.e., ≥) 0.5 SCFM (Standard Cubic Feet per Minute), ≥1.5 SCFM, ≥2.5 SCFM, ≥3.5 SCFM, ≥4.5 SCFM, ≥5.5 SCFM, ≥6.5 SCFM, ≥7.5 SCFM, ≥8.5 SCFM, ≥9.5 SCFM, ≥10.5 SCFM, ≥11.5 SCFM, ≥12.5 SCFM, ≥13.5 SCFM, ≥14.5 SCFM, or greater. In some embodiments, the air flow rate at the inlet 348 may be less than or equal to (i.e., ≤) 15 SCFM, ≤14 SCFM, ≤13 SCFM, ≤12 SCFM, ≤11 SCFM, ≤10 SCFM, ≤9 SCFM, ≤8 SCFM, ≤7 SCFM, ≤6 SCFM, ≤5 SCFM, ≤4 SCFM, ≤3 SCFM, ≤2 SCFM, ≤1 SCFM, or less. In some embodiments, the air flow rate at the inlet 348 may be greater than or equal to (i.e., ≥) 0.5 SCFM and less than or equal to (i.e., ≤) 15 SCFM-including all sub-ranges or values therebetween. For example, in some embodiments, the air flow rate at the inlet 348 may be ≥0.5 SCFM and ≤15 SCFM, ≥0.5 SCFM and ≤12 SCFM, ≥0.5 SCFM and ≤9 SCFM, ≥0.5 SCFM and ≤6 SCFM, ≥0.5 SCFM and ≤3 SCFM, ≥3 SCFM and ≤15 SCFM, ≥3 SCFM and ≤12 SCFM, ≥3 SCFM and ≤9 SCFM, ≥3 SCFM and ≤6 SCFM, ≥6 SCFM and ≤15 SCFM, ≥6 SCFM and ≤12 SCFM, ≥6 SCFM and ≤9 SCFM, ≥9 SCFM and ≤15 SCFM, ≥9 SCFM and ≤12 SCFM, ≥9 SCFM and ≤6 SCFM, or ≥12 SCFM and ≤15 SCFM.

In some embodiments, the pressure of the cooling fluid at the inlet 348 may be greater than or equal to (i.e., ≥) 5 psi, ≥15 psi, ≥25 psi, ≥35 psi, ≥45 psi, ≥55 psi, ≥65 psi, ≥75 psi, ≥85 psi, ≥95 psi, ≥105 psi, ≥115 psi, or greater. In some embodiments, the pressure of the cooling fluid at the inlet 348 may be less than or equal to (i.e., ≤) 120 psi, ≤110 psi, ≤100 psi, ≤90 psi, ≤80 psi, ≤70 psi, ≤60 psi, ≤50 psi, ≤40 psi, ≤30 psi, ≤20 psi, ≤10 psi, or less. In some embodiments, the pressure of the cooling fluid at the inlet 348 may be greater than or equal to (i.e., ≥) 5 psi and less than or equal to (i.e., ≤) 120 psi-including all sub-ranges or values therebetween. In some embodiments, the pressure of the cooling fluid at the inlet 348 may be ≥5 psi and ≤120 psi, ≥5 psi and ≤90 psi, ≥5 psi and ≤60 psi, ≥5 psi and ≤30 psi, ≥30 psi and ≤120 psi, ≥30 psi and ≤90 psi, ≥30 psi and ≤60 psi, ≥60 psi and ≤120 psi, ≥60 psi and ≤90 psi, or ≥90 psi and ≤120 psi.

In some embodiments, the flowrate and/or the pressure may be selected based at least in part on the operating condition (including but not limited to operating current, temperature of the electric motor 100 (e.g., temperature of the magnetic core 260 of the rotor 200, temperature of the stator winding 360 of the stator 300)) of the electric motor 100. For example, in some embodiments, the cooling fluid may be flowed at about 2 SCFM and/or 15 psi at the inlet 348 to provide about 135 W of continuous heat dissipation when the nominal operating point of the electric motor 100 may be about 4.5 A. As another non-limiting example, the flowrate of the cooling fluid at the inlet 348 may be greater than or about 12 SCFM and/or about 80 psi to achieve effective heat dissipation when the nominal operating point of the electric motor 100 may be increased to 5.5 A. As a further non-limiting example, the flowrate of the cooling fluid at the inlet 348 may be selected such that the temperature of the electric motor 100 (e.g., the temperature of the stator winding 360 and/or the magnetic core 260) may not be too high (e.g., less than or equal to 125 °C) to allow the electric motor 100 to operate continuously without thermal breakdown and demagnetization of the permanent magnets.

In some embodiments, the flowrate and/or the pressure may be selected based at least in part on the sound level at the annular slit 356 from which the cooling fluid may exit the electric motor 100 such that the sound level at the annular slit 356 may be sufficiently low or appropriate for the operating environment of the electric motor 100. As a non-limiting example, when the cooling fluid, such as cooling air, may be flowed at about 2 SCFM and/or 15 psi at the inlet 348, the sound of the air exiting the electric motor 100 may be about 83 dBA.

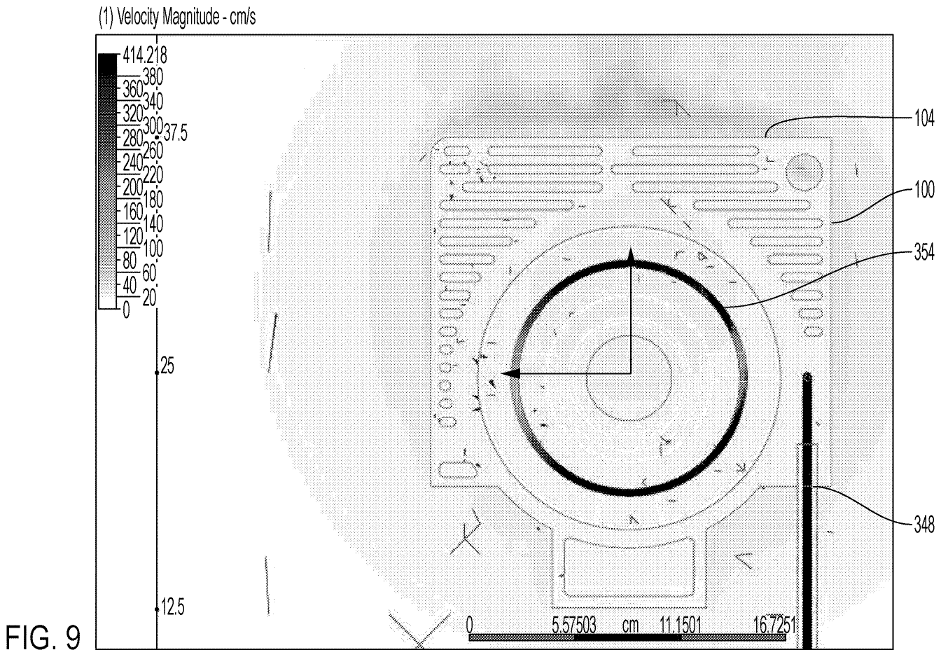

FIG. 9 shows simulation of the velocity magnitude (cm/s) of the cooling fluid through the inlet 348 of the electric motor 100 and the annular gap 354 between the stator winding 360 and the rotor 200. As also shown in FIG. 9, the natural convection at the top 104 of the electric motor 100, as facilitated by the heat sink fins 336, also contributes to the heat dissipation.

FIG. 10 shows simulation of the velocity magnitude (cm/s) of the cooling fluid, through the annular gap 354 between the stator winding 360 and the rotor 200 and exiting at the annular slit 356 of the electric motor 100, at a flow rate of 2 SCFM at the inlet 348.

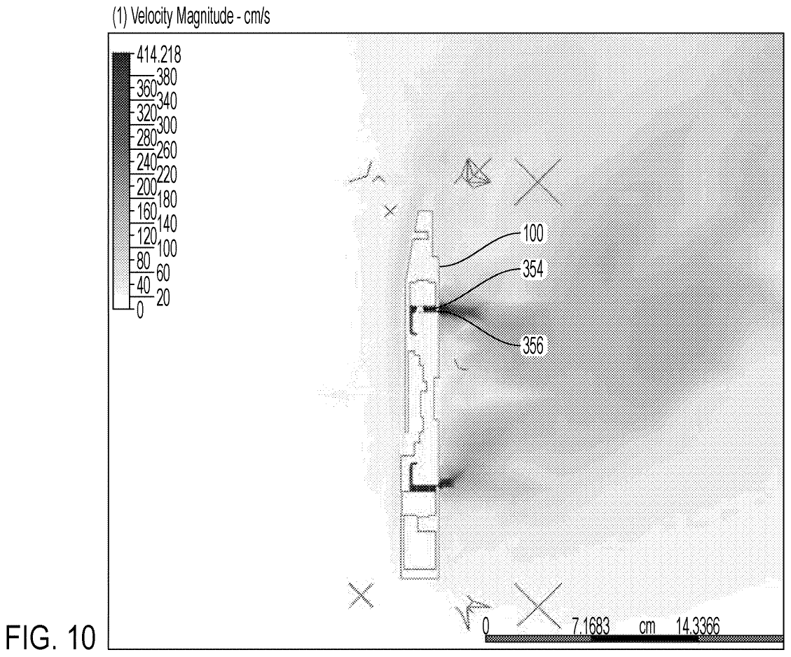

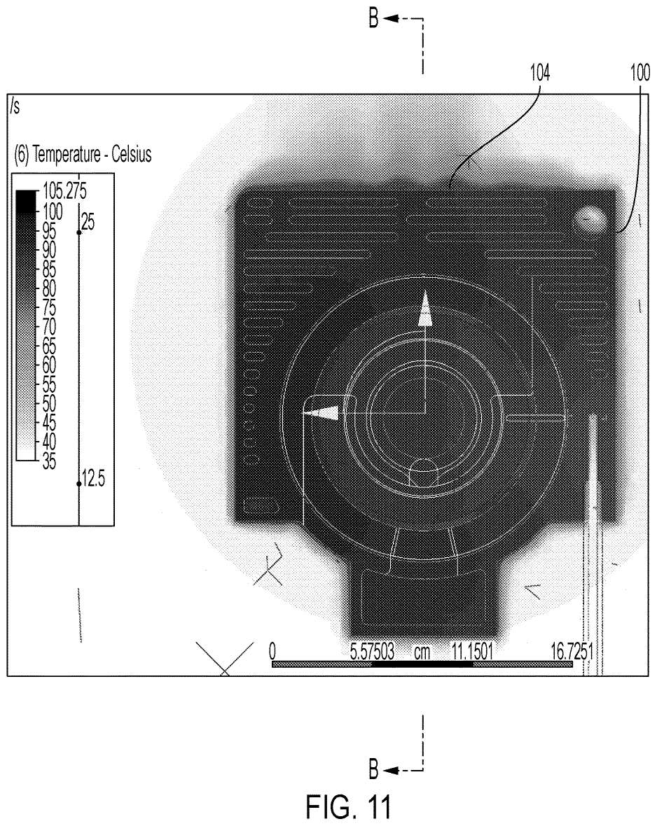

FIG. 11 shows simulation of the temperature distribution (in ° °C) within and around the electric motor 100. As shown, the peak temperature is about 105 °C, and the temperature of the stator winding 360 ranges from about 90 °C to about 95 °C when the flow of the cooling fluid is configured to provide 135 W of thermal heat lost at the nominal operating point of 4.5 A. Also shown in FIG. 11 is the natural convection at the top 104 of the electric motor 100.

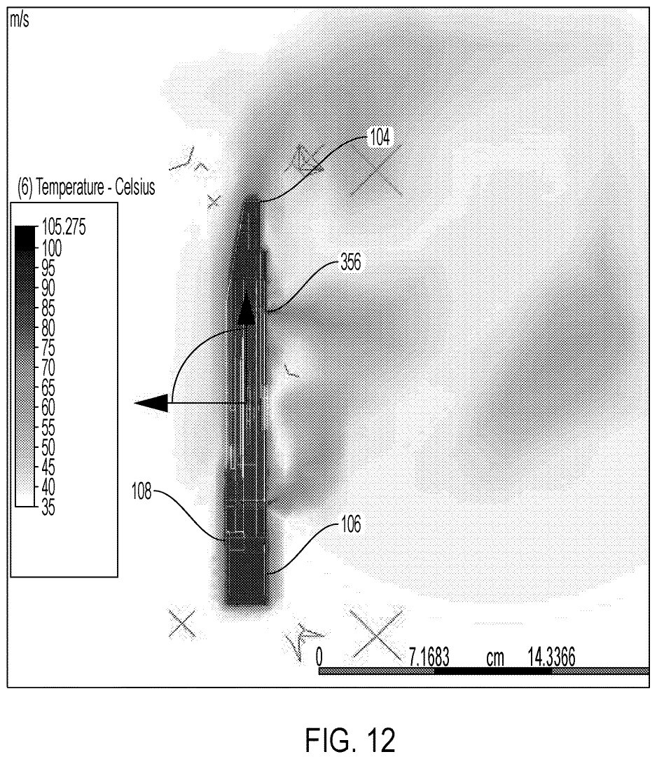

FIG. 12 shows simulation of the temperature distribution (in °C) of a cross section of the electric motor 100 taken along plane B-B of FIG. 11 and air exiting the electric motor 100 through the annular slit 356. Both the forced convection through the annular slit 356 on one side 106 of the electric motor 100 and the natural convection through the heat sink fins 336 on the opposite side 108 towards the top 104 of the electric motor 100 are shown in FIG. 12. It should be noted that in the simulations discussed above, the electric motor 100 is in an upright configuration. However, the electric motor 100 may be configured in any orientation, depending on the applications.

### Bearing

As discussed above, the bearing 400, more specifically, the first bearing race 410 and the second bearing race 440, may be configured to facilitate relative rotational movement between the rotor 200 and the stator 300 and/or to limit relative axial movement between the rotor 200 and the stator 300. As also discussed above, in some embodiments, the first bearing race 410 may be coupled and/or secured to the stator 300 by, e.g., being coupled and/or secured to the step 332 of the stator housing 310 by the retainer plate 334, such that the first bearing race 410 may remain stationary relative to the stator 300 during operation of the electric motor 100. As also discussed above, in some embodiments, the second bearing race 440 may be coupled and/or secured to the rotor 200 by, e.g., being coupled and/or secured to the rotor shaft 210 by the fasteners 216, such that the second bearing race 440 may rotate with the rotor 200 during the operation of the electric motor 100.

In some embodiments, the first bearing race 410 or at least a portion thereof may be received in a recess collectively defined by the second bearing race 440 and the rotor shaft 210. Specifically, in some embodiments, the second bearing race 440 may include an inner step 448 (see FIG. 4), more specifically, a radially inward facing step 448, in part defining the recess for receiving at least the portion of the first bearing race 410. The second bearing race 440 and the rotor shaft 210 may be configured such that the first bearing race 410 may rotate relative to the second bearing race 440 while being positioned inside the recess. The first bearing race 410 may include a first surface 412 and a second surface 414 opposite the first surface 412 in the axial direction. As discussed above, a clearance may be provided between the surface portion 228 of the second side 220 of the rotor shaft 210 and the first surface 412 of the first bearing race 410 facing the rotor shaft 210 to facilitate the relative rotational movement between the rotor shaft 210 and the first bearing race 410. In some embodiments, the first surface 412 and the second surface 414 may each define an axial end of the first bearing race 410, and thus, the distance between the first surface 412 and the second surface 414 may define the axial length of the first bearing race 410.

In some embodiments, the bearing 400 may include a cross-roller bearing. Accordingly, in some embodiments, the rollers 430 may include cylindrical rollers positioned at right angles (crossed) to each other in a raceway defined by the first bearing race 410 and the second bearing race 440. In some embodiments, the first bearing race 410, the second bearing race 440, and/or the rollers 430 may be made of stainless steel (e.g., 440C) or any other suitable materials.

By utilizing the bearing 400 described herein, such as a single cross roller bearing, instead of two separate ball bearings disposed on opposite axial ends of the stator of conventional servo motors, the bearing 400 of the electric motor 100 described herein may be disposed radially inward from the stator winding 360 without protruding axially beyond the stator winding 360. Such radial arrangement, instead of axial arrangement in conventional servo motors, allows for a much shorter axial length of the electric motor 100 to be achieved while maintain the load bearing capacity.

### Feedback Device

In some embodiments, the bearing 400 may define a large center bore so that various components of the electric motor 100 or portions thereof may be arranged radially inside the bearing 400 to reduce the axial dimension of the electric motor 100. Referring back to FIG. 4, in some embodiments, the electric motor 100 may include a feedback device 500 configured about the motor axis 102 and disposed radially inside the bearing 400.

In some embodiments, the feedback device 500 may include an induction ring 506 and an inductive reader head 508, both of which may be disposed radially inward from the bearing 400. In some embodiments, the feedback device 500 may include a mounting frame 510 configured for mounting the inductive reader head 508 to the stator housing 310 and for maintaining a space between the induction ring 506 and the inductive reader head 508 in the axial direction. In some embodiments, the electric motor 100 may further include a cover plate 358 secured to the stator housing 310 to protect the feedback device 500 so that the feedback device 500 may be protected. In some embodiments, the feedback device 500 may include a hollow bore 504 centered around the motor axis 102 and extending through the induction ring 506, the inductive reader head 508, and the cover plate 358. The hollow bore 504 may be configured to allow cables and optical passthrough.

As can be seen from FIG. 4, in some embodiments, the feedback device 500 may be disposed in a region axially recessed from the first surface 316 of the first side 312 of the stator housing 310. In some embodiments, the cover plate 358 may also be disposed in the recessed region axially recessed from the first surface 316 of the first side 312 of the stator housing 310. Thus, in some embodiments, the feedback device 500, as well as the cover plate 358, may not extend axially beyond the axial end of the stator 300 as defined by the first surface 316 of the first side 312 of the stator housing 310, reducing the axial length of the electric motor 100. In other words, in some embodiments, the feedback device 500 may be disposed within the assembly of the rotor 200 and stator 300 in the axial direction. In contrast, in conventional motors, a feedback device is typically mounted to axially behind the rotor and stator assembly and thus, extends axially beyond or outside the rotor and stator assembly, adding to the overall axial length of the conventional motors.

With continue reference to FIG. 4, in some embodiments, the induction ring 506 may be disposed radially inward from the stator housing 310. In some embodiments, the induction ring 506 may be seated into a step 230 formed on the second side 220 (or the interior side 220) of the rotor shaft 210 and mounted or secured thereto. Thus, in some embodiments, the induction ring 506 may be integrated into the rotor shaft 210 such that protrusion of the induction ring 506 beyond the interior axial end 226 of the rotor shaft 210 in the axial direction may be limited. The integration of the induction ring 506 into the rotor shaft 210 may reduce the stack-up length of the feedback device 500 beyond the interior axial end 226 of the rotor shaft 210, thereby reducing the overall axial dimension of the electric motor 100.

In some embodiments, the induction ring 506 may include an axial length less than the axial length of the bearing 400. In some embodiments, the axial length of the induction ring 506 may be less than the axial length of the first bearing race 410 and/or the axial length of the second bearing race 440. Thus, in some embodiments, the induction ring 506 may be fitted within the axial space defined by the first surface 412 and the second surface 414 of the first bearing race 410 and/or the axial space defined by the first surface 452 and the second surface 454 of the second bearing race 440 to reduce the overall axial length of the electric motor 100. As shown in FIG. 4, in some embodiments, the combined axial length of the feedback device 500 and the rotor shaft 210 may be less than the axial length of the electric motor 100.

### Torque Delivery for Extended Periods of Time at Stall

As will be discussed in more detail below, in some embodiments, the electric motor 100 may simulate a constant force spring, and thus, may operate at stall while providing torque for extended periods of time.

Conventional servo motors typically use back electromotive force (back EMF) from the rotating rotor magnets in a running motor as a feedback to detect relative position between the stator and the rotor, or a low resolution encoder to allow ongoing measurement of this relative position at low rotational velocities or temporary stoppages. However, when the motor is operating at stall continuously, it can be challenging to determine the position of the rotor relative to the stator due to the lack of such back EMF feedback precisely. To overcome such challenge, the feedback device 500 described herein may be configured to detect the relative position of the rotor 200 and stator 300 while the electric motor 100 is at stall. Thus, the feedback device 500 may be configured to provide phase feedback, position control, and/or velocity control to ensure the magnetic flux of the stator winding 360 appropriately leads the permanent magnet flux to generate a precise amount of torque, e.g., maximum torque in some instances, while the electric motor 100 is at stall.

Specifically, in some embodiments, the feedback device 500 may include an absolute encoder for sensing the positions of the magnets 264 relative to the induction ring 506 when the rotor 200 is moving and/or is at stall. The absolute nature of the feedback device 500 permits tracking of the rotor position even after power is lost. Thusly, the electric motor 100 can start running at stall immediately after regaining power in the constant force spring application (described below) without needing to perform a homing sequence or pulse phase angle determination algorithm at startup. In order to obtain the phase angle between the magnets 264 and the winding units 368 (i.e., relative angle between the magnetic field of the permanent magnets 264 and the electrically generated magnetic field by the winding units 368), after the electric motor 100 is assembled, the rotor 200 is rotated relative to the stator winding 360, and the back EMF feedback generated by the rotation of the rotor 200 is used for determining the phase angle of the magnets 264 of the rotor 200 relative to the winding units 368 of the stator 300. With the combined knowledge of the relative phase angle between the magnets 264 and the winding units 368 and the position of the magnets 264 relative to the induction ring 506, the feedback device 500 can constantly provide knowledge of the position of the magnets 264 relative to the winding units 368 even when the electric motor 100 is operating at stall, which further enables optimal amount, e.g., maximum amount, of torque to be generated consistently. The relative position/phase angle data are stored in a non-volatile memory within the feedback device 500, so immediate recovery can occur in the spring application (described below) in the instance power is lost, or the motor cable and motor controller unit is separated from the electric motor 100 temporarily. It should be noted that when at stall, slight movement of the rotor 200 relative to the stator 300 may still occur, but the amount of back EMF generated may not be sufficient for position detection by conventional motor designs. The electric motor 100 described herein allows for constant detection of the phase angle between the magnets 264 and the winding units 368 even when the rotor 200 is at stall with low uncertainty, thereby allowing the electric motor 100 to operate as a constant spring to deliver optimal amount of torque continuously. In some embodiments, the feedback device 500 may include a high-resolution feedback device 500 to allow for maintaining precise phase angle knowledge to enable repeatable and smooth torque delivery throughout the rotation at stall to enable operation similar to a constant force spring, in addition to precise servo motor positioning. In some embodiments, the electric motor 100 may be capable of maintaining the relative phase angle between the magnets 264 and the winding units 368 to be within +0.001° of the desired phase angle, delivering precise amount of torque desired for various applications.

### Dimensions

The axial dimension or the axial length of the electric motor 100, which may also be referred to as the thickness of the electric motor 100, is defined as the maximum distance between the opposite sides 106 and 108 of the electric motor 100 in the axial direction. In some embodiments, the first surface 316 of the first side 312 of the stator housing 310 may define a first axial end on the side 108 of the electric motor 100, and the second surface 318 of the second side 314 of the stator housing 310 may define a second axial end on the side 106 of the electric motor 100. Thus, in some embodiments, the axial length or thickness of the electric motor 100 is defined by the distance between the first surface 316 of the first side 312 of the stator housing 310 and the second surface 318 of the second side 314 of the stator housing 310. In some embodiments, the surface 214 of the first side 212 of the rotor 200, the exterior surface of the retainer plate 330, the second surface 318 of the second side 314 of the stator housing 310, and/or the exterior surface of the cover plate 114 may be coplanar and may collectively define the second axial end on the side 106 of the electric motor 100, which may be planar or substantially planar. Thus, in some embodiments, the axial length or thickness of the electric motor 100 also corresponds to the distance between the first surface 316 of the first side 312 of the stator housing 310 and the surface 214 of the first side 212 of the rotor 200 in the axial direction, the distance between the first surface 316 of the first side 312 of the stator housing 310 and the exterior surface of the retainer plate 330 in the axial direction, the distance between the first surface 316 of the first side 312 of the stator housing 310 and the second surface 318 of the second side 314 of the stator housing 310 in the axial direction, and/or the distance between the first surface 316 of the first side 312 of the stator housing 310 and the exterior surface of the cover plate 114 in the axial direction.

In some embodiments, the configuration of the electric motor 100 described herein may allow for an ultra-thin, compact design to be implemented. In some embodiments, the axial length or thickness of the electric motor 100 may be less than or equal to (i.e., ≤) 1.5 inches, ≤1.4 inches, ≤1.3 inches, ≤1.2 inches, ≤1.1 inches, ≤1 inch, ≤0.9 inches, ≤0.8 inches, or less. In some embodiments, the thickness of the electric motor 100 may be greater than or equal to (i.e., ≥) 0.75 inches. In some embodiments, the thickness of the electric motor 100 may be greater than or equal to (i.e., ≥) 0.75 inches and less than or equal to (i.e., ≤) 1.5 inches-including all sub-ranges or values therebetween, such as ≥0.75 inches and ≤1.5 inches, ≥0.75 inches and ≤1.25 inches, ≥0.75 inches and ≤1 inches, ≥1 inch and ≤1.5 inches, ≥1 inch and ≤1.25 inches, or ≥1.25 inches and ≤1.5 inch. Such ultra-thin and compact design the electric motor 100 described herein may allow for applications in constraint spaces where conventional servo motors may not be suitable. However, it should be noted that the electric motor 100 described herein is not limited to the axial length of thickness described herein. The electric motor 100 described herein may be implemented or scaled to any dimensions or thickness depending on the particular applications.

In some embodiments, a ratio of an effective outer diameter of the stator housing 310 to the axial length or thickness of the electric motor 100 may be greater than or equal to 6 and less than or equal to 12—including all sub-ranges or values therebetween. The effective outer diameter of the stator housing 310 is defined as the minimum of the lengths of all lines that (i) extend between peripheral edges extending between the first side 312 and the second side 314 of the stator housing 310 and (ii) also pass and are perpendicular to the motor axis 102. As a non-limiting example, in some embodiments, the effective outer diameter of the stator housing 310 of the electric motor 100 corresponds to the length of the line in the plane A-A shown in FIG. 1 extending between the periphery edges 313 and 315 and perpendicular to the motor axis 102. In some embodiments, the ratio of the effective outer diameter of the stator housing 310 to the axial length or thickness of the electric motor 100 may be greater than or equal to (i.e., ≥) 6 and less than or equal to (i.e., ≤) 12, ≥6 and ≤10, ≥6 and ≤8, ≥8 and ≤12, ≥8 and ≤10, or ≥10 and ≤12. In some embodiments, the ratio of the effective outer diameter of the stator housing 310 to the axial length or thickness of the electric motor 100 may be greater than or equal to (i.e., ≥) 6, ≥6.5, ≥7, ≥7.5, ≥8, ≥8.5, ≥9, ≥9.5, ≥10, ≥10.5, ≥11, ≥11.5, or greater. In some embodiments, the ratio of the effective outer diameter of the stator housing 310 to the axial length or thickness of the electric motor 100 may be less than or equal to (i.e., ≤) 12, ≤11.5, ≤11, ≤10.5, ≤10, ≤9.5, ≤9, ≤8.5, ≤8, ≤7.5, ≤7, ≤6.5, or less.

Referring to FIG. 1, the retainer plate 330 for securing the stator winding 360 to the stator housing 310 may include a circular outer periphery 331 along the majority thereof, and the circular periphery may define an outer diameter of the retainer plate 330. In some embodiments, a ratio of the outer diameter of the retainer plate 330 to the axial length or thickness of the electric motor 100 may be greater than or equal to 6 and less than or equal to 12-including all sub-ranges or values therebetween. For example, in some embodiments, the ratio of the outer diameter of the retainer plate 330 to the axial length or thickness of the electric motor 100 may be greater than or equal to (i.e., ≥) 6 and less than or equal to (i.e., ≤) 12, ≥6 and ≤10, ≥6 and ≤8, ≥8 and ≤12, ≥8 and ≤10, or ≥10 and ≤12. In some embodiments, the ratio of the outer diameter of the retainer plate 330 to the axial length or thickness of the electric motor 100 may be greater than or equal to (i.e., ≥) 6, ≥6.5, ≥7, ≥7.5, ≥8, ≥8.5, ≥9, ≥9.5, ≥10, ≥10.5, ≥11, ≥11.5, or greater. In some embodiments, the ratio of the outer diameter of the retainer plate 330 to the axial length or thickness of the electric motor 100 may be less than or equal to (i.e., ≤) 12, ≤11.5, ≤11, ≤10.5, ≤10, ≤9.5, ≤9, ≤8.5, ≤8, ≤7.5, ≤7, ≤6.5, or less.

The electric motor 100 described herein may achieve high torque to thickness ratio. In some embodiments, the ratio of the torque (Nm) to the thickness (mm) of the electric motor 100 may be greater than or equal to (i.e., ≥) 0.1 Nm/mm, ≥0.11 Nm/mm, ≥0.12 Nm/mm, ≥0.13 Nm/mm, ≥0.14 Nm/mm, ≥0.15 Nm/mm, ≥0.16 Nm/mm, ≥0.17 Nm/mm, ≥0.18 Nm/mm, ≥0.19 Nm/mm, ≥0.2 Nm/mm, ≥0.21 Nm/mm, ≥0.22 Nm/mm, ≥0.23 Nm/mm, ≥0.24 Nm/mm, ≥0.25 Nm/mm, ≥0.26 Nm/mm, ≥0.27 Nm/mm, ≥0.28 Nm/mm, ≥0.29 Nm/mm, or greater. In some embodiments, the ratio of the torque (Nm) to the thickness (mm) of the electric motor 100 may be greater than or equal to (i.e., ≥) 0.1 Nm/mm and less than or equal to (i.e., ≤) 0.3 Nm/mm-including all sub-ranges or values therebetween. For example, in some embodiments, the ratio of the torque (Nm) to the thickness (mm) of the electric motor 100 may be greater than or equal to (i.e., ≥) 0.1 Nm/mm and less than or equal to (i.e., ≤) 0.3 Nm/mm, ≥0.1 Nm/mm and ≤0.25 Nm/mm, ≥0.1 Nm/mm and ≤0.2 Nm/mm, ≥0.15 Nm/mm and ≤0.3 Nm/mm, ≥0.15 Nm/mm and ≤0.25 Nm/mm, ≥0.15 Nm/mm and ≤0.2 Nm/mm, ≥0.2 Nm/mm and ≤0.3 Nm/mm, ≥0.2 Nm/mm and ≤0.25 Nm/mm, or ≥0.25 Nm/mm and ≤0.3 Nm/mm.

### Optical Fiber Production

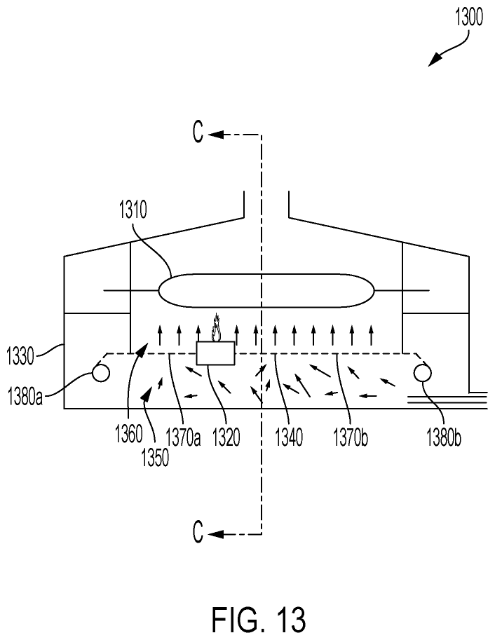

As a non-limiting exemplary application of the electric motor 100, the electric motor 100 described herein may be used for soot preform production, which may be used as a precursor for producing optical fibers, mirrors or other optical components, etc. FIG. 13 schematically illustrates a system 1300 incorporating the electric motor 100 described herein for producing a soot preform 1310. In some embodiments, the soot preform 1310 may contain silica deposited using a burner 1320 configured to traverse the entire length of the soot preform 1310. The burner 1320 and the soot preform 1310 may be enclosed in a housing 1330 of the system 1300. In some embodiments, the system 1300 may further include a perforated floor 1340 to regulate the airflow inside the housing 1330. More details of the system 1300 are described in U.S. patent application Ser. No. 18/376,195, the content of which is incorporated by reference in its entirety.

In some embodiments, the perforated floor 1340 may be configured to direct the non-uniform airflow from a lower portion 1350 of the housing 1330 into an upper portion 1360 of the housing 1330, in which the flow may be generally uniform. In some embodiments, the perforated floor 1340 may include two perforated sheets 1370a, 1370b. One end of each of the perforated sheets 1370a, 1370b may be coupled to the burner 1320, and the other end of the each of the perforated sheets 1370a, 1370b may be coupled to a drum 1380a, 1380b. As the burner 1320 traverses the length of the soot preform 1310 back and forth inside the housing 1330, one of the perforated sheets 1370a, 1370b may be extended and rolled out from the drum 1380a, 1380b, and the other one of the perforated sheets 1370a, 1370b may be contracted and rolled back onto the drum 1380a, 1380b. In some instances, instead of the coupled to the drums 1380a, 1380b, the ends of the perforated sheets 1270a, 1270b may each be coupled to a spring for maintaining a tight tension on the perforated sheets 1370a, 1370b so that the perforated floor 1340 remains flat and taut as the burner 1320 traverses back and forth along the length of soot preform 1310, such as described in U.S. patent application Ser. No. 18/376,195 mentioned above.

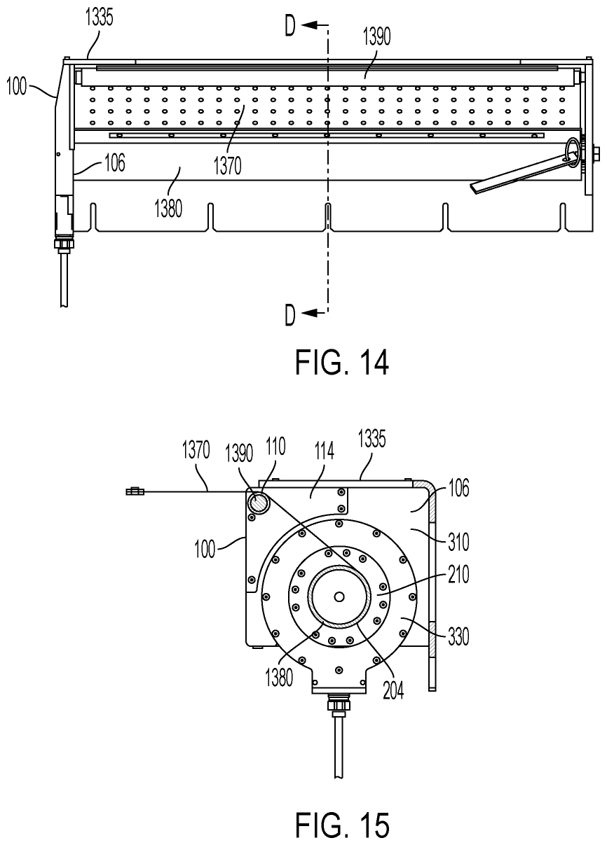

In the system 1300 described herein, instead of using a spring, each of the drum 1380a, 1380b may be coupled to a motor, such as the electric motor 100 described herein. Referring to FIG. 14, an interior side view of a portion of the system 1300 viewed in the direction C-C of FIG. 13 is shown. In FIG. 14, only the electric motor 100, the perforated sheet 1370, and select parts and components for coupling the perforated sheet 1370 to the electric motor 100 are shown, while the housing 1330, the burner 1320, the soot preform 1310, and the like are not shown. FIG. 15 is a cross-sectional view of the portion of the system 1300 shown in FIG. 14 taken along plane D-D of FIG. 14.

In some embodiments, when coupled to the perforated sheet 1370, the entire electric motor 100 may be exposed to the interior space inside the housing 1330. Depending on the processes carried out, the electric motor 100 may be exposed to a corrosive environment. As discussed above, the surfaces of the electric motor 100 may be formed of a corrosion-resistant material, such as anodized material. Additionally, the cooling fluid exiting the electric motor 100 at the annular slit 356 may also serve as a seal or air purge to prevent any contaminants from entering into the interior of the electric motor 100 such that the interior components of the electric motor 100 may be protected from the exterior environment.

With continued reference to FIGS. 14 and 15, in some embodiments, the electric motor 100 may be mounted to a wall plate 1335, and the drum 1380 may be received in the hollow bore 204 of the rotor shaft 210 and coupled to the rotor shaft 210. The electric motor 100 may simulate a constant force spring for maintaining the tight tension in the perforated sheet 1370 while the perforated sheet 1370 is extended from or retracted onto the drum 1380 through the rotation of the rotor shaft 210 of the electric motor 100. In some embodiments, a roller 1390 may be received in the through hole 110 and coupled to the electric motor 100 for guiding the perforated sheet 1370.

Depending on the particular process being carried out, the perforated sheets 1370 may be moved in either direction (i.e., extended or retracted) at any speed via the rotation of the rotor shaft 210 of the electric motor 100, or may remain stationary for extended period of time. As mentioned above, the electric motor 100 described herein can deliver precise amount of torque through the entire process (during rotation or at stall) for maintaining the tension in the perforated floor 1340, including delivering a precise amount of torque, e.g., maximum torque, at stall for extended period of time without overheating.

Utilizing the electric motor 100 described herein for extending and/or retracting the perforated sheets 1370 may increase the operation cycles without failure as compared to a spring, thereby increasing up time and reducing repair and maintenance costs. Additionally, the electric motor 100 described herein may enable torque application longevity while eliminating issues like dynamic seals, belts, and/or chains that would be needed to integrate traditional servomotors in the control volume of the system 1300. Further, the electric motor 100 described herein may maintain low inertia experienced by the perforated sheets 1370 when changing directions and/or speed when compared to other drum-integrated motor solutions, such as conveyor rollers, which may not be a feasible alternative due to the inertial limitations of the internal gearing of the conveyor rollers. The electric motor 100 described herein achieves all of the above with an ultra-thin, compact design, which further offers reduced size and cost savings by reducing the supporting hardware in various applications.

### EXAMPLES

### Comparison to Conventional Servo Motor

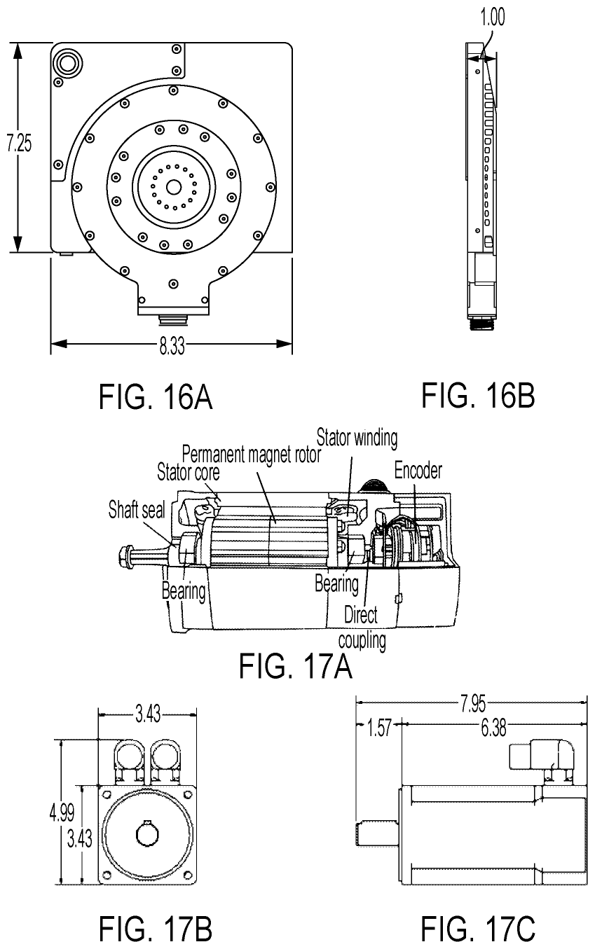

FIGS. 16A, 16B, 17A, 17B, and 17C compares the dimensions of an example of the electric motor 100 described herein with a conventional servo motor from the International Research Journal of Engineering and Technology, Volume 10, Issue 3, Automatic Coil Winding Machine, Pawaskar et. al. FIG. 16A shows a side view of the exemplary electric motor 100 in the axial direction. FIG. 16B shows a side view of the exemplary electric motor 100 in the transverse direction. FIG. 17A shows a perspective view of the conventional servo motor. FIG. 17B shows a side view of the conventional servo motor in the axial direction. FIG. 17C shows a side view of the conventional servo motor in the transverse direction.

As can be seen, the conventional servo motor is significantly thicker in the axial direction than the ultra-thin exemplary electric motor 100 due to the ball bearings on the axial ends of the rotor of the conventional servo motor. In contrast, the single cross-roller bearing 400 of the electric motor 100 described herein is positioned inside the rotor 200 that allows for an ultra-thin design. Additionally, the encoder of the conventional servo motor is attached to the end of the rotor, while the feedback device 500 of the electric motor 100 described herein can be at least partially integrated with the rotor 200.

Table 1 below provides the performance attributes of the conventional motor and the exemplary electric motor 100. As shown, the electric motor 100 described herein provides for an ultra-thin (about ⅛ of the conventional motor), much more compact design while achieving similar or even better performance characteristics compared to the conventional motor.

TABLE 1

| | Conventional | Exemplary Electric |
|---|---|---|
| Attribute | Motor | Motor 100 |
| Rated Torque (Nm) | 3.9 | 4.2 |
| Standstill Torque (Nm) | 4.1 | 4.3 |
| Peak Torque (Nm) | 18.9 | 11.5 |
| Rated Speed (RPM) | 2500 | 3000 |
| Rated Power (kW) | 1.02 | 1.29 |
| Standstill Current (A) | 2.15 | 4.5 |
| Peak Current (A) | 11.8 | 12 |
| Torque Constant (Nm/A) | 1.9 | 0.962 |

### Performance Simulations and Measurements

The performance of the exemplary electric motor 100 described herein is simulated, including steady state/magnetostatic and dynamic direct quadrature and finite element modeling. For the simulation, the exemplary electric motor 100 is configured to extend and/or retract the perforated sheets 1370 of the soot preform production system 1300 described above. For this particular application, the exemplary electric motor 100 achieves 4.2 Nm torque delivery continuously and 11.5 Nm peak with 3000 RPM max speed. 3.2 Nm to 4 Nm of torque is produced at 1320 rpm.

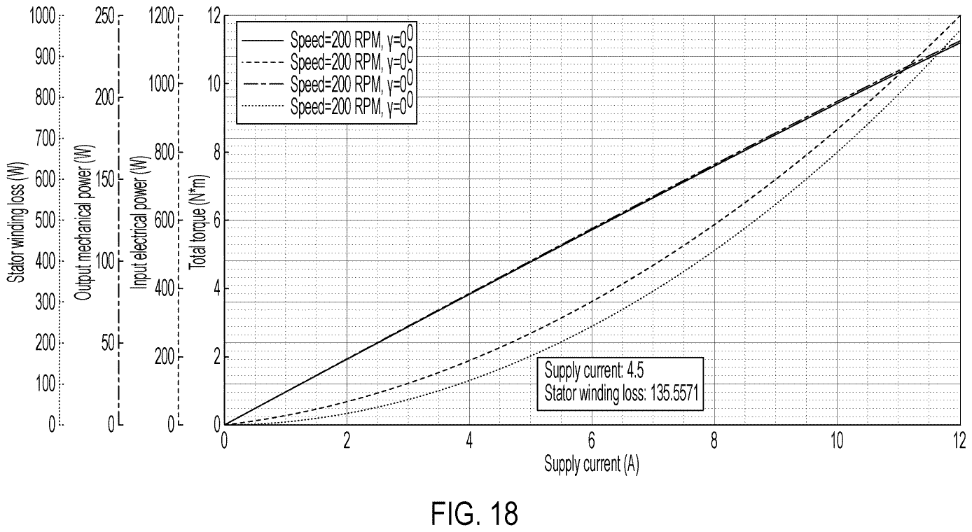

FIG. 18 shows the simulation of the torque performance and winding losses based on direct quadrature model. The simulation shows that a motor temperature of about 105 °C can be maintained with about 130 W of heat being produced within the exemplary electric motor 100. Continuous operation at higher temperature and/or current can be achieved. For example, the exemplary electric motor 100 can operate at 120 °C continuously, and produces 4.14 Nm torque at 4.3 amps supplied while generating about 135 W of thermal energy lost. In some instances, the exemplary electric motor 100 can endure 12 amps for about 5 seconds without thermal breakdown and demagnetization of the permanent magnets. It should be noted that the simulation only considered natural and forced convection for heat dissipation. Depending on the application environment, thermal conduction through the mounting surface may also facilitate heat dissipation, thereby allowing an even higher operation current. For example, when mounted to the housing 1330 of the system 1300, the exemplary electric motor 100 can operate at about 100 °C with 4.5 amps supplied.

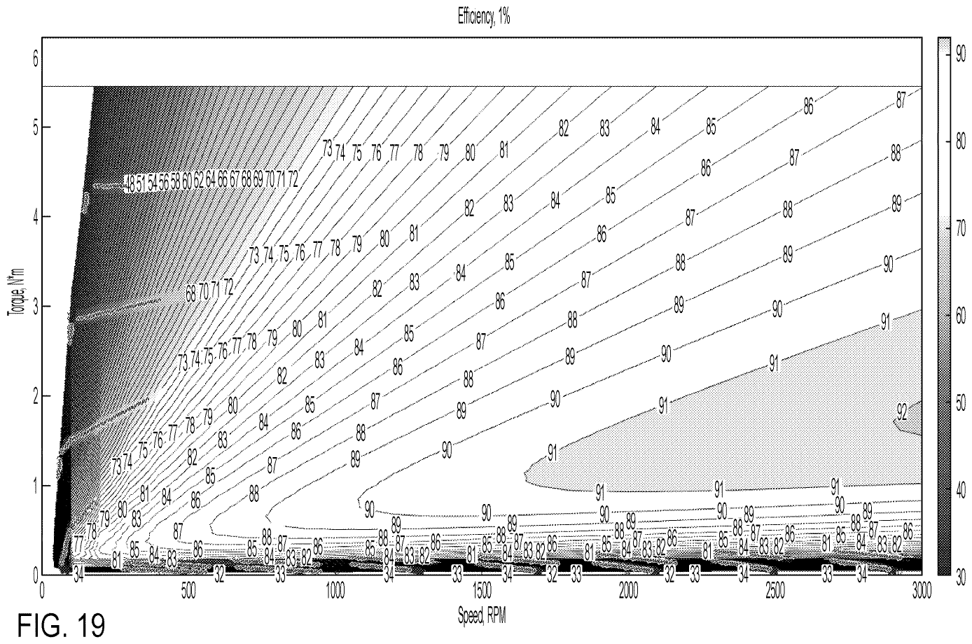

FIG. 19 shows the efficiency curve for the exemplary electric motor 100. When consistently rotating at several hundred RPM, the exemplary electric motor 100 can achieve efficiency in the 85-92% region.

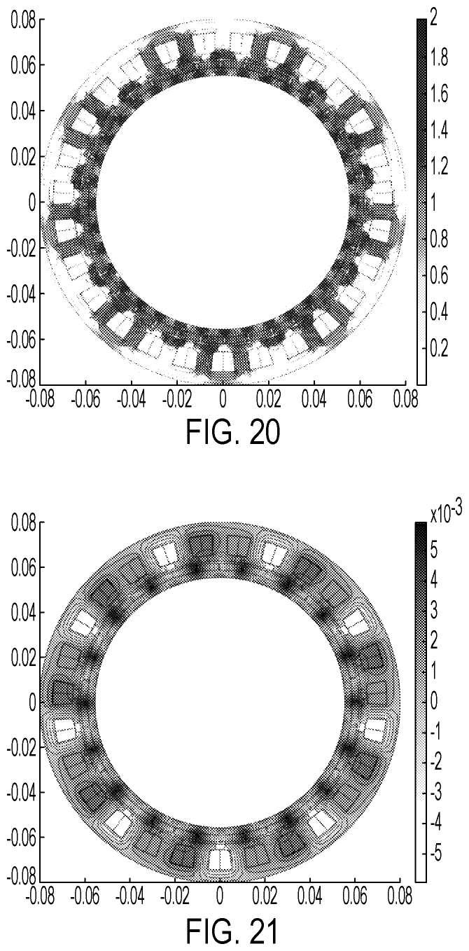

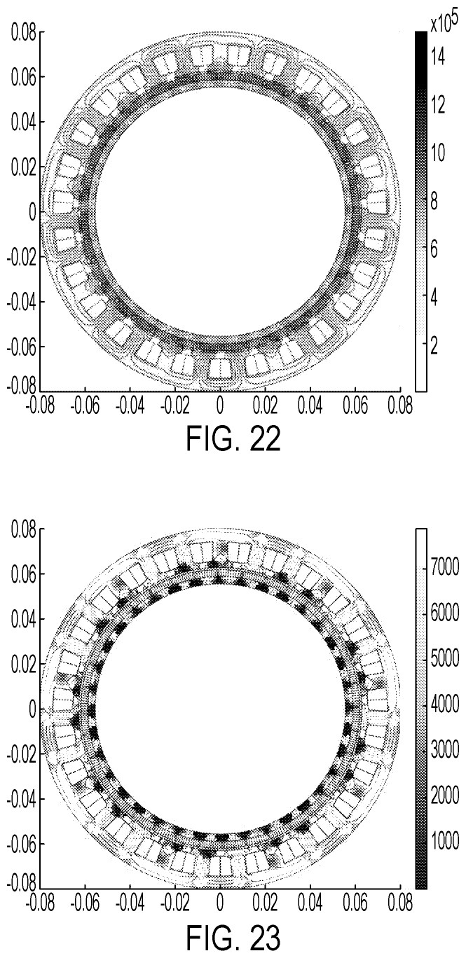

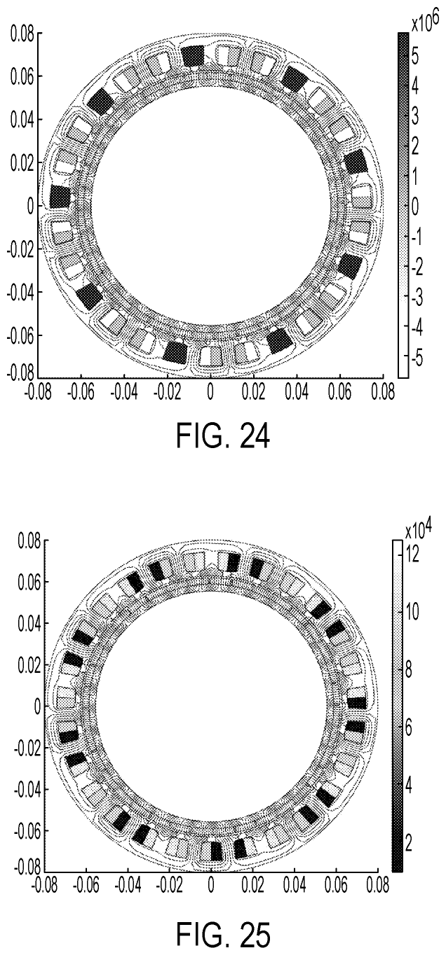

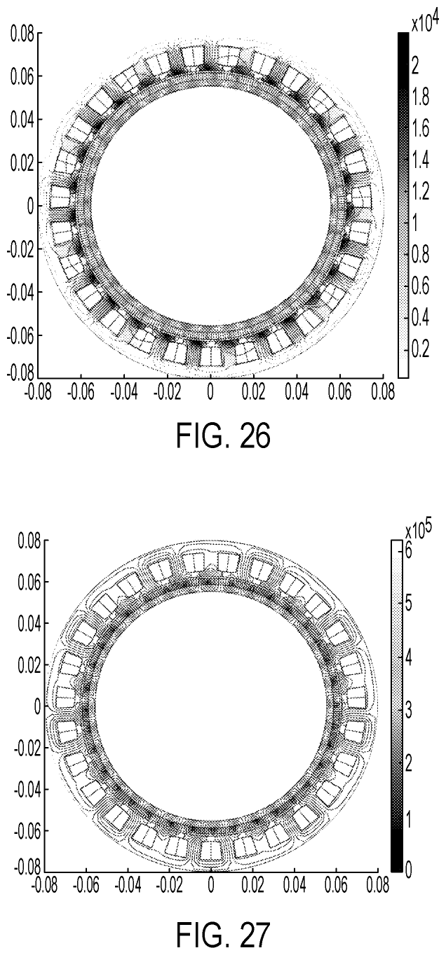

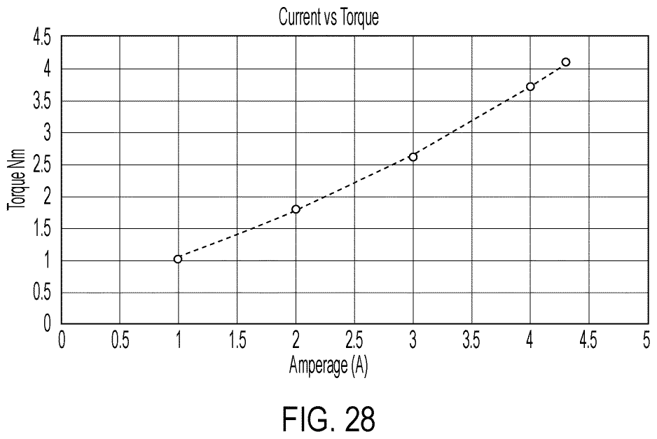

To validate performance characteristics, simulations were conducted and measurements were taken. FIG. 20 shows flux density (T) finite element simulation conducted 48 steps over 1 electrical period at the maximum needed torque current value (4.3 A). FIG. 21 shows magnetic vector potential (T*m) finite element simulation conducted 48 steps over 1 electrical period at the maximum needed torque current value (4.3 A). FIG. 22 shows magnetic field intensity (A/m) finite element simulation conducted 48 steps over 1 electrical period at the maximum needed torque current value (4.3 A). FIG. 23 shows relative magnetic permeability finite element simulation conducted 48 steps over 1 electrical period at the maximum needed torque current value (4.3 A). FIG. 24 shows stator current density (A/m²) finite element simulation conducted 48 steps over 1 electrical period at the maximum needed torque current value (4.3 A). FIG. 25 shows stator loss density (W/m³) finite element simulation conducted 48 steps over 1 electrical period at the maximum needed torque current value (4.3 A). FIG. 26 shows back iron loss density (W/m³) finite element simulation conducted 48 steps over 1 electrical period at the maximum needed torque current value (4.3 A). FIG. 27 shows magnet demagnetizing risk (A/m) finite element simulation conducted 48 steps over 1 electrical period at the maximum needed torque current value (4.3 A). FIG. 28 shows measured torque performance as a function of current. In operation, the exemplary electric motor 100 delivers comparable or better performance than simulation.

### Exemplary Stator and Rotor Layout

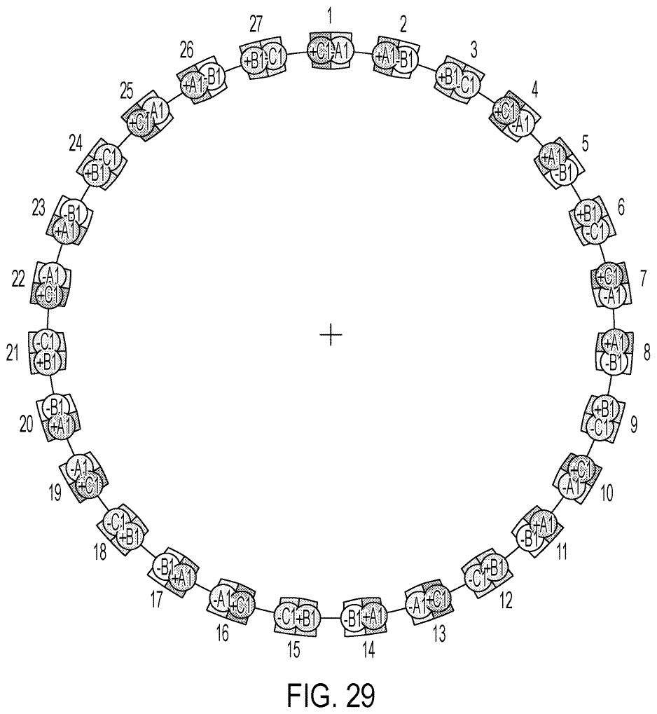

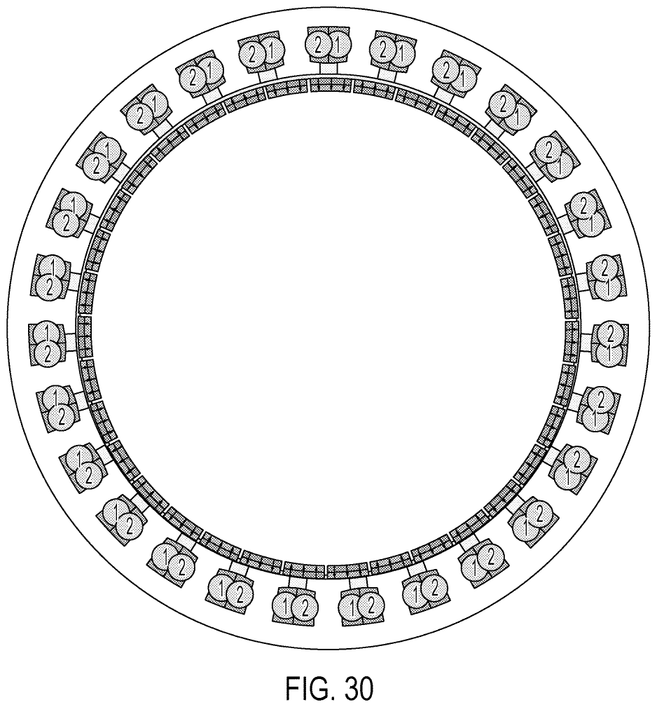

FIG. 29 shows an exemplary winding layout of the exemplary electric motor 100 described herein. FIG. 30 shows an exemplary stator slot and rotor layout of the exemplary electric motor 100 described herein, which employs the winding layout of FIG. 29. Table 2 shows the winding layout chart for the stator slot number connection. Table 3 shows the motor constants of the exemplary electric motor 100.

TABLE 2

| Coil | Slot from | Slot to |
|---|---|---|
| Phase A | | |
| 1 | 2 | 1 |
| 2 | 5 | 4 |
| 3 | 8 | 7 |
| 4 | 11 | 10 |
| 5 | 14 | 13 |
| 6 | 17 | 16 |
| 7 | 20 | 19 |
| 8 | 23 | 22 |
| 9 | 26 | 25 |
| Phase B | | |
| 1 | 3 | 2 |
| 2 | 6 | 5 |
| 3 | 9 | 8 |
| 4 | 12 | 11 |
| 5 | 15 | 14 |
| 6 | 18 | 17 |
| 7 | 21 | 20 |
| 8 | 24 | 23 |
| 9 | 27 | 26 |
| Phase C | | |
| 1 | 4 | 3 |
| 2 | 7 | 6 |
| 3 | 10 | 9 |
| 4 | 13 | 12 |
| 5 | 16 | 15 |
| 6 | 19 | 18 |
| 7 | 22 | 21 |
| 8 | 25 | 24 |
| 9 | 1 | 27 |

TABLE 3

| Motor Property | Units | Value |
|---|---|---|
| Velocity Constant | RPM/V | 12.2815 |
| Back-EMF Constant | V/RPM | 0.081424 |
| Torque Constant | Nm/A | 0.962412 |
| Motor Constant | Nm/sqrt(W) | 0.371974 |

The exemplary electric motor 100 has a high least common multiple of 108, with 27 stator slots and 18 rotor magnetic pole pairs. The high least common factor can minimize cogging of the electric motor 100 described herein by reducing the number of simultaneous rotor permanent magnet pole alignments with the electrical phase(s) slots with the highest torque generating flux density, thereby enabling smooth torque delivery to simulate a constant force spring. The cogging torque at the nominal condition is about 0.4 Nm or 10% of the supplied torque. The maximum torque ripple is about 26.4% across the whole operational span. To achieve a comparable characteristics, conventional motors typically require much greater volume and/or size using rotor skew, etc.

It will be apparent to those skilled in the art that various modifications to the preferred embodiments of the disclosure as described herein can be made without departing from the spirit or scope of the disclosure as defined in the appended claims. Thus, the disclosure covers the modifications and variations provided they come within the scope of the appended claims and the equivalents thereto.

What is claimed is:

1. An electric motor, comprising:
a rotor, comprising:
a rotor rotational axis;
a rotor shaft configured to rotate about the rotor rotational axis; and
a magnetic core;
a stator, comprising:
a stator housing; and
a stator winding received in the stator housing; and
a bearing, comprising:
a first bearing race coupled to the stator housing such that the first bearing race remains stationary relative to the stator housing during operation of the electric motor; and
a second bearing race disposed radially outward from the first bearing race and coupled to the rotor shaft such that the second bearing race rotates with the rotor shaft during the operation of the electric motor; and
rollers disposed between the first bearing race and the second bearing race;
wherein during the operation of the electric motor, the first bearing race and the second bearing race are configured to cooperate to limit relative axial movement between the rotor and the stator.

2. The electric motor of claim, wherein the bearing comprises a cross-roller bearing.

3. The electric motor of claim, wherein:
the stator housing comprises a cavity defined by an inner lateral wall, an outer lateral wall extending in an axial direction parallel to the rotor rotational axis, and a base extending between the inner lateral wall and the outer lateral wall; and
at least a portion of the stator winding, at least a portion of the magnetic core, and/or at least a portion of the bearing are/is disposed in the cavity of the stator housing.

4. The electric motor of claim, wherein the stator winding is disposed radially outward from the magnetic core.

5. The electric motor of claim, wherein the magnetic core comprises a back iron and a magnet, wherein the magnet is disposed radially outward from the back iron, and wherein the back iron is received in a recess defined at least in part by the second bearing race.

6. The electric motor of claim, wherein a portion of the first bearing race is configured to be received in a recess defined at least in part by the stator housing.

7. The electric motor of claim, wherein the rotor shaft defines a hollow bore through which the rotor rotational axis extends.

8. The electric motor of claim, further comprising:
a feedback device disposed radially inward from the bearing, wherein the feedback device satisfies at least one of:
wherein the feedback device defines a hollow bore through which the rotor rotational axis extends;
wherein the feedback device is disposed within a recessed region formed by the stator housing about the rotor rational axis; and/or
wherein a combined axial length of an axial length of the feedback device and an axial length of the rotor shaft is less than or equal to an axial length of the electric motor.

9. The electric motor of claim, wherein the stator housing comprises heat dissipating fins disposed on an exterior of the electric motor.

10. The electric motor of claim, further comprising a cooling channel for delivering a cooling fluid through at least a portion of the electric motor.

11. The electric motor of claim, wherein the cooling channel is defined at least in part by the stator housing.

12. The electric motor of claim, wherein the stator housing is configured to deliver the cooling fluid through a first gap between the stator winding and the rotor, and wherein the electric motor is configured to allow the cooling fluid to exit from the electric motor through a second gap at a major surface of the electric motor.

13. The electric motor of claim, wherein an axial length of the electric motor is greater than or equal to 0.75 inches and/or less than or equal to 1.5 inches.

14. The electric motor of claim, wherein a ratio of an effective outer diameter of the stator housing to an axial length of the electric motor is greater than or equal to 6 and/or less than or equal to 12.

15. The electric motor of claim, wherein a ratio of torque the electric motor is configured to generate to an axial length of the electric motor is greater than or equal to 0.1 Nm/mm and/or less than or equal to 0.3 Nm/mm.

16. A system for producing a precursor for making optical fiber, the system comprising the electric motor of claim.

17. An electric motor, comprising:
a rotor configured to rotate about a rotor rotational axis;
a stator; and
a bearing comprising:
a first bearing race coupled to the stator;
a second bearing race coupled to the rotor disposed radially outward from the first bearing race; and
rollers disposed between the first bearing race and the second bearing race;
wherein the first bearing race, the second bearing race, and the rollers are configured to cooperate to facilitate relative rotational movement between the rotor and stator; and
wherein the first bearing race and the second bearing race are further configured such that relative axial movement between the rotor and the stator is limited at least impart by the first bearing race and the second bearing race.

18. The electric motor of claim, wherein the bearing comprises a cross-roller bearing.

19. The electric motor of claim, wherein the first bearing race is coupled to a stator housing of the stator, and wherein the first bearing race is configured to be received in a recess defined at least in part by the stator housing.

20. The electric motor of claim, wherein the second bearing race is coupled to a rotor shaft of the rotor.

21. The electric motor of claim, wherein:
the rotor comprises a magnetic core;
the stator comprises a stator winding; and
the stator winding is disposed radially outward from the magnetic core.

22. An electric motor, comprising:
a rotor configured to rotate about a rotor rotational axis;
a stator;
a bearing configured to facilitate relative rotational movement between the rotor and stator and configured to limit relative axial movement between the rotor and the stator; and
an interior cooling channel configured for directing a cooling fluid to flow into the electric motor, wherein the electric motor is configured to deliver the cooling fluid through a first gap between the stator and the rotor, and wherein the electric motor is configured to allow the cooling fluid to exit from the electric motor through a second gap at a surface at an axial end of the electric motor.
